(19) United States
(12) Patent Application Publication
(10) Pub. No.: US 2026/0072507 A1
(43) Pub. Date: Mar. 12, 2026

(54) VIBRATION BASED INTERACTION SYSTEM FOR ON BODY DEVICE AND METHOD

(71) Applicant: UNIVERSITY OF VIRGINIA PATENT FOUNDATION, Charlottesville, VA (US)

(72) Inventors: Zhencan PENG, Hong Kong (CN); Shupei LIN, Hong Kong (CN); John A. STANKOVIC, Earlysville, VA (US); Wenqiang CHEN, Cambridge, MA (US)

(73) Assignees: UNIVERSITY OF VIRGINIA PATENT FOUNDATION, Charlottesville, VA (US); Vibint AI Limited, Hong Kong (CN)

(21) Appl. No.: 19/109,729

(22) PCT Filed: Sep. 13, 2023
(86) PCT No.: PCT/US2023/074073

§ 371 Date: Mar. 7, 2025

Related U.S. Application Data
(60) Provisional application No. 63/406,138, filed on Sep. 13, 2022.

(51) Int. Cl. G06F 3/01; G04G 21/02; G06N 3/0895

(52) U.S. Cl. CPC G06F 3/016; G06F 3/011; G06F 3/017; G06N 3/0895; G04G 21/02

(57) ABSTRACT

Disclosed are various embodiments for recognition of on body touch interactions and gestures using an on-body device. A sample of vibration data from the vibration sensor is input into a trained convolutional neural network. The vibration data is generated from a vibration event. In response, the trained convolutional neural network outputs one of a plurality of predefined vibration event descriptors. The trained convolutional neural network is adapted based at least in part on a plurality of Siamese contrastive loss calculations. Each Siamese contrastive loss calculation is generated from a corresponding pair of preexisting samples of vibration data from a pool of preexisting samples of vibration data.

### CROSS REFERENCE TO RELATED CASES

This application claims priority to, and the benefit of, U.S. Provisional Patent Application No. 63/406,138, filed on Sep. 13, 2022, which is incorporated herein in its entirety.

### BACKGROUND

Various devices such as smart watches and the like have screens or other interfaces that are rather small. This can result in interaction with such devices that is somewhat tedious. Also, errors may more frequently occur during interaction with such devices.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1.1A, 1.1B, and 1.1C depicts examples of a portion of a human body that includes touch interaction positions or that shows gestures from which vibration events are detected by a device according to various embodiments of the present disclosure.

FIG. 1.2 is a schematic diagram of a processor circuit included in a device of FIGS. 1.1A, 1.1B, and 1.1C according to various embodiments of the present disclosure.

FIG. 1.3 depicts an example of a convolutional neural network implemented in the processor circuit of FIG. 1.2 according to various embodiments of the present disclosure.

FIG. 1.4 is a flow chart that depicts an example of functionality implemented by the processor circuit of FIG. 1.2 according to various embodiments of the present disclosure.

FIG. 1.5 depicts a retraining of the convolutional neural network of FIG. 1.3 according to various embodiments of the present disclosure.

FIG. 1.6 depicts a networked environment that implements a remote retraining of the convolutional neural network implemented in the processor circuit of FIG. 1.2 according to various embodiments of the present disclosure.

FIG. 2.1 depicts an example of a detection of a touch interaction according to various embodiments of the present disclosure.

FIG. 2.2 depicts an example measurement of performance under differing circumstances according to various embodiments of the present disclosure.

FIG. 2.3 depicts an example measurement of vibration amplitude according to various embodiments of the present disclosure.

FIG. 2.4 depicts an overview according to various embodiments of the present disclosure.

FIG. 2.5 depicts an example architecture of the convolutional neural network of FIG. 1.3 according to various embodiments of the present disclosure.

FIG. 2.6 depicts an example architecture of the domain discriminator of FIG. 1.5 according to various embodiments of the present disclosure.

FIG. 2.7 depicts an example architecture of the domain discriminator of FIG. 1.5 adapted by Siamese contrastive loss calculations according to various embodiments of the present disclosure.

FIG. 2.8 depicts an example of a confusion matrix according to various embodiments of the present disclosure.

FIG. 2.9 depicts an example comparison of accuracy measurement of devices according to various embodiments of the present disclosure.

FIG. 2.10 depicts an example comparison of neural networks according to various embodiments of the present disclosure.

FIG. 2.11 depicts an example of accuracy measurements comparing the convolutional neural network of FIG. 1.5 and the domain discriminator adapted by the Siamese contrastive loss calculations of FIG. 2.7 according to various embodiments of the present disclosure.

FIG. 2.12 depicts an example of accuracy measurements of target user training according to various embodiments of the present disclosure.

FIG. 2.13 depicts an example of accuracy measurements of the convolutional neural network for unseen users according to various embodiments of the present disclosure.

FIG. 2.14 depicts an example of accuracy measurements of the domain discriminator adapted by the Siamese contrastive loss calculations of FIG. 2.7 over seven days according to various embodiments of the present disclosure.

FIG. 2.15 depicts a chart of responses to questions related to system usability of applications developed for devices according to various embodiments of the present disclosure.

FIG. 2.16 depicts a chart comparing measurements of workload related to devices using a system built using supervised fine-tuning and devices using the system built according to various embodiments of the present disclosure.

### SUMMARY

In one embodiment, an apparatus is described that comprises a device configured to be positioned on a human body. Also, the apparatus includes a vibration sensor in the device. Furthermore, at least one processor circuit in the device has a memory comprising instructions that cause the processor circuit to input a sample of vibration data from the vibration sensor into a trained convolutional neural network. In this embodiment, the vibration data is generated from a vibration event and the trained convolutional neural network outputs one of a plurality of predefined vibration event descriptors. Additionally, the trained convolutional neural network is adapted based at least in part on a plurality of Siamese contrastive loss calculations, which are generated from a corresponding pair of preexisting samples of vibration data from a pool of preexisting samples of vibration data.

In another embodiment, another apparatus is described that comprises a device that is configured to be positioned on a human body and also includes a vibration sensor. In addition, at least one processor circuit in the device has a memory comprising instructions, that when executed by the processor circuit, causes the processor circuit to input a sample of vibration data from the vibration sensor into a trained convolutional neural network. In this embodiment, the vibration data is generated from a touch interaction and the trained convolutional neural network outputs one of a plurality of predefined touch interaction positions. Furthermore, the embodiment retrains the trained convolutional neural network in relation to the plurality of predefined touch interaction positions. This is based at least in part on a difference in loss value of the sample of vibration data compared to a preexisting sample of vibration data. Accordingly, the retraining of the trained convolutional neural network includes adapting the trained convolutional neural network using a plurality of Siamese contrastive loss calculation. Individual ones of the Siamese contrastive loss calculations are generated from a corresponding pair of preexisting samples of vibration data from a pool of preexisting samples of vibration data.

In yet another embodiment, a method is described that comprises inputting a sample of vibration data from a vibration sensor into a trained convolutional neural network. In this embodiment, the vibration data is generated from a touch interaction and the trained convolutional neural network outputs one of a plurality of predefined touch interaction positions. Furthermore, the trained convolutional neural network is retrained periodically based at least in part a plurality of Siamese contrastive loss calculations. In this embodiment, each Siamese contrastive loss calculation is generated from a corresponding pair of samples of vibration data, which are from a pool of samples of vibration data. Additionally, the pool of samples of vibration data are generated by individual ones of a plurality of source domains and a target domain.

### DETAILED DESCRIPTION

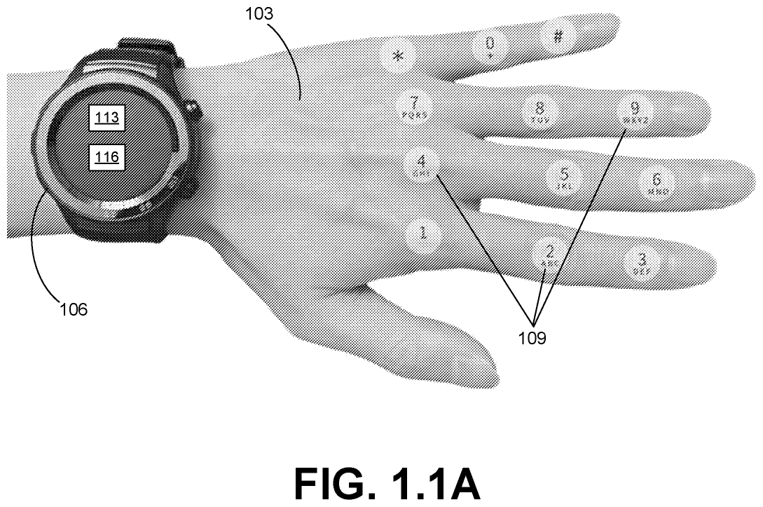

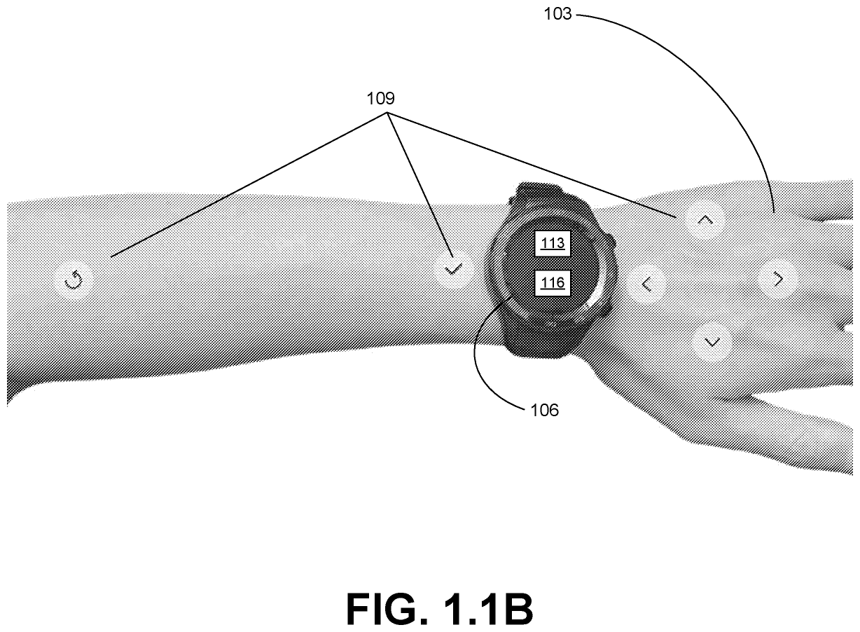

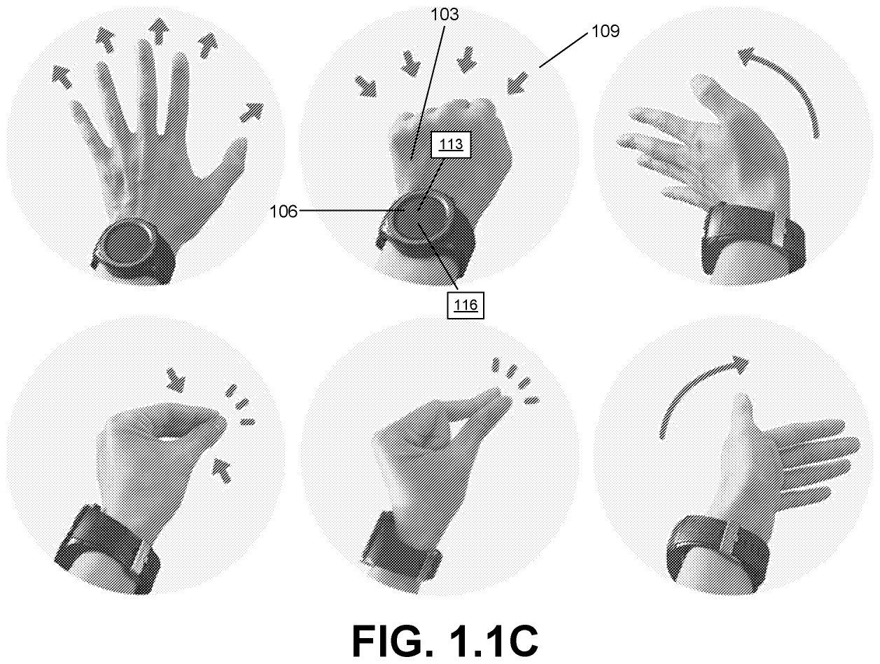

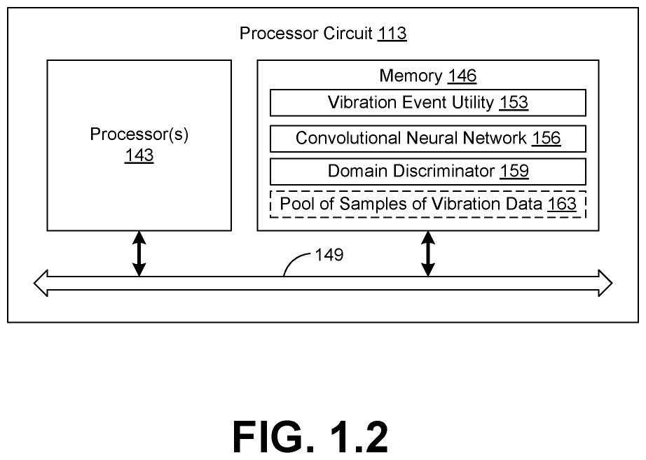

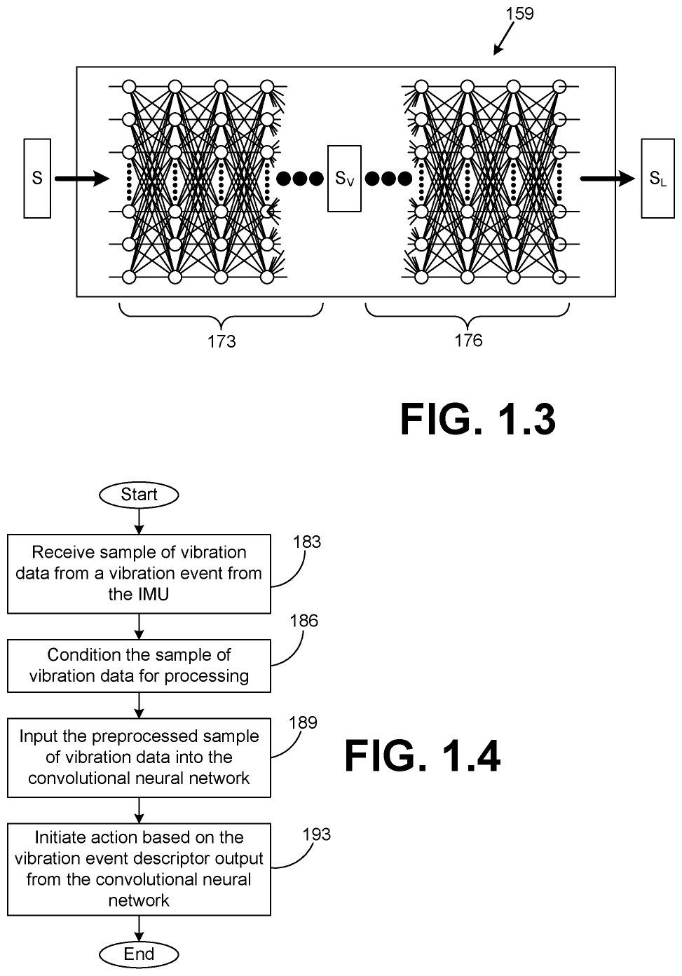

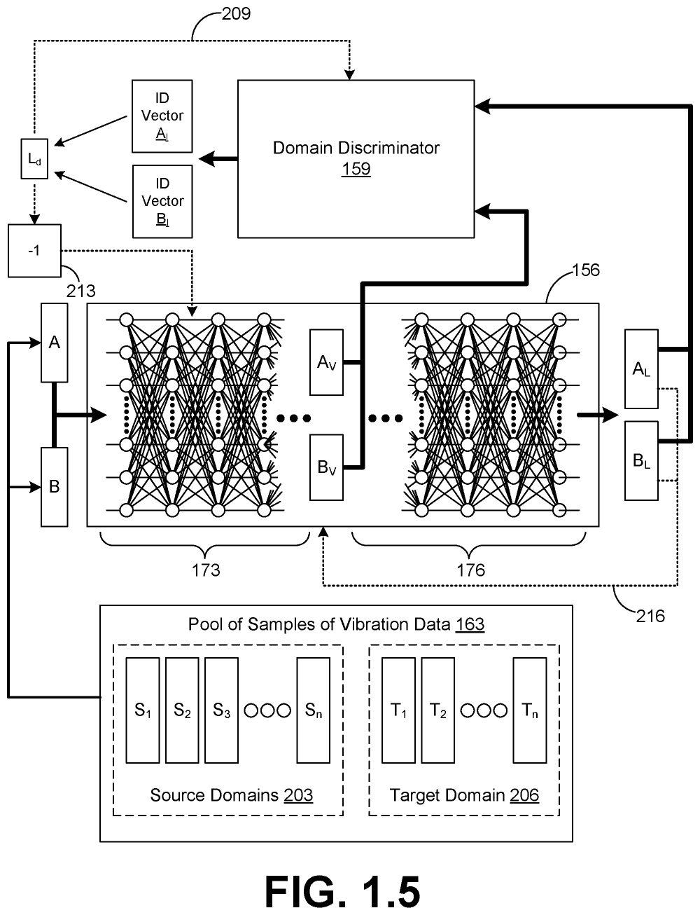

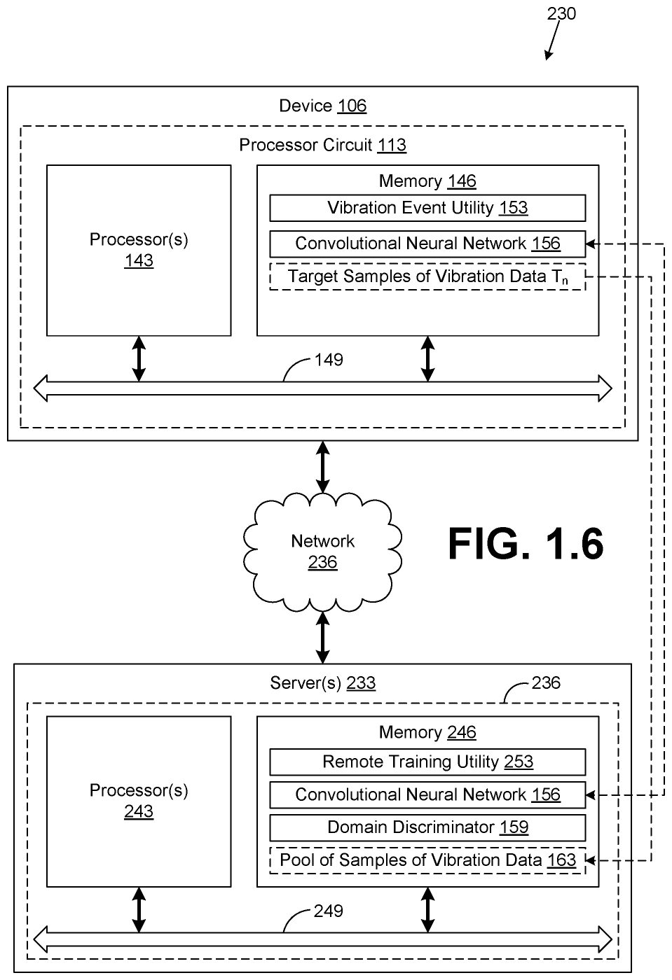

Referring to FIG. 1.1A, shown is a body part 103 of a human body such as, for example, a portion of a forearm and a hand. It is understood that the body part 103 may alternatively comprise, for example, a different portion of a human body such as a leg, an ankle, a foot, a shoulder, an arm, a torso, or other body part. Positioned on the body part 103 is a device 106. In one example, the computing device 106 is a smartwatch. Alternatively, the device 106 could be a ring, a wristband, an ankle bracelet, a wearable, glasses, or other device. The device 106 includes at least a processor circuit 113 and a vibration sensor 116. In addition, various touch interaction positions 109 are specified on the body part 103. In other words, predefined touch interaction positions 109 on the body part 103 have been made conspicuous.

In one embodiment, the vibration sensor 116 associated with the device 106 comprises a gyroscope and an accelerometer. By virtue of the gyroscope and accelerometer, the vibration sensor 116 senses vibration from a vibration event and generates a corresponding signal. The sensed vibration event may be a predefined vibration event and may be unique or a plurality of vibration events.

A vibration event comprises a collision made at a level of force to cause vibration that can be sensed by the vibration sensor 116. Such vibration may last for a limited amount of time. A vibration event may also comprise the vibration made by a gesture using the body part 103 as will be described. The vibration event could be repeated with collision occurring repeatedly at the same or different levels of force for the same or different periods of time. The collision may comprise, for example, a tap, hit, or other type of collision. In one example, the source of the collision could be a finger, a hand, or something else that is caused to collide with touch interaction positions 109 on the body part 103. In one embodiment, the vibration event occurs at the touch interaction positions 109 on the body part 103 that are located within a predefined distance from the device 106 so that the vibration caused by the vibration event is sensed by the vibration sensor 116.

Upon detection of the vibrations from a vibration event, the vibration sensor creates a signal that captures the vibration. Typically, such signals last for a brief period of time. The signal may carry surplus information, including relevant and irrelevant details. In one embodiment, the signals undergo pre-processing to remove irrelevant information such as low frequency information that might be generated, for example, by random or unrelated movement of the body part 103. For example, the touch interaction may occur along with another unintended collision that effects the vibration of the vibration event.

In other words, along with details concerning an intended touch interaction or gesture, a signal might carry noise with it that might affect the relevant details concerning the touch interaction. The processor pre-processes the signal to distinguish between the intended touch interaction information and the noise, and substantially removes the unwanted noise from the signal.

In one embodiment, the vibration sensor 116 comprises an inertial measurement unit (IMU) that includes an accelerometer, a gyroscope, and a magnetometer. Such vibration sensors 116 may comprise standard sensors in commercial-off-the-shelf smart watches or other devices. In other embodiments, the vibration sensor 116 may comprise other components to optimally serve a similar function for a similar purpose.

According to one embodiment, there may be a plurality of different types of vibration events. In one embodiment, the vibration event may comprise a touch interaction with a respective one of the touch interaction positions 109. For example, one may use a finger from a free hand to tap on one or more of the touch interaction positions 109. Alternatively, a vibration event may comprise a gesture that is implemented with the body part 103 such as a grabbing motion or a wave.

For each vibration event, the vibration sensor 116 generates a sample of vibration data that is provided to the processor circuit 113.

Assuming that a vibration event comprises a touch interaction with one of the touch interaction positions 109, once the sample of vibration data is received from the vibration sensor 116, the processor circuit 113 determines the touch interaction location 109 where the touch interaction has occurred. Alternatively, the processor circuit 113 determines what type of gesture is made with the body part as will be described. According to one embodiment, several touch interaction positions 109 may be specified to form a keypad such as is noted on the knuckles of the hand in FIG. 1.1A. Alternatively, other touch interaction positions 109 may be specified such as, for example, directional arrows, return buttons, and others. As shown in the example of FIG. 1.1A, an interpretation by the processor circuitry 113 of vibration events could result in making a phone call with the computing device 106 or a separate computing device connected to the computing device 106 on a shared network or other actions might be initiated.

FIG. 1.1B is comprised of information similar to that presented in FIG. 1.1A. As depicted in FIG. 1.1B, according to one embodiment, the touch interaction positions 109 comprise a set of directional arrows, an “accept” check mark button, and a “back” button. A notable detail presented by FIG. 1.1B is the fact that vibration sensor 116 within the device 106 can detect a vibration event that occurs at least as far as near an elbow of the body part 103 on which the device 106 is disposed. The distance between a given touch interaction position 109 and the device 106 is specified so that the vibrations generated by touch interaction on the touch interaction position 109 can be sensed by vibration sensor 116 in the device 106.

FIG. 1.1C is similar to FIG. 1.1A and FIG. 1.1B but also presents notable distinctions. FIG. 1.1C displays another type of vibration event. For example, in FIG. 1.1C, the vibration event comprises one of a plurality of predefined gestures made with the body part 103. For example, when the body part 103 comprises a human hand, one might open the hand, close or grip the hand, make a pinch gesture, make a snap gesture, wave to the left, wave to the right, or some other gesture. The sample of vibration data generated as a result of a vibration event is communicated to the device 106 in a similar manner as described above. At least in this example, an interpretation by the processor circuitry 113 of the vibration event could result in browsing a webpage on the smartwatch or a separate computing device connected to the computing device 106 on a shared network.

With reference to FIG. 1.2, shown is a schematic block diagram of the processor circuit 113 resident on the device 106 according to an embodiment of the present disclosure. The processor circuit 113 includes a processor 143 and a memory 146 including instructions, both of which are coupled to a local interface 149. The local interface 149 may comprise, for example, a data bus with an accompanying address/control bus or other bus structure as can be appreciated.

Stored in the memory 146 are instructions, data, and several components that are executable by the processor 143. In particular, stored in the memory 146 and executable by the processor 143 are instructions including a vibration event utility 153, a convolutional neural network 156, a discriminator 159, and potentially other applications. The convolutional neural network 156 and the discriminator 159 are each part of a domain adversarial neural network (DANN) as is described below. Also stored in the memory 146 are various data elements such as, for example, a pool of samples of vibration data 163 and other data. In other words, the memory 146 includes at least, for example, a pool of preexisting samples of vibration data 163 along with other data. In addition, an operating system or other operating elements may be stored in the memory 146 and executable by the processor 143 as can be appreciated.

The vibration event utility 153 is implemented in the processor circuit 113 to orchestrate the operation of the individual applications and components stored in the memory 146 in order to recognize a given vibration event. In response to the recognition that a given vibration event has a occurred, the vibration event utility 153 initiates a predefined action in the device 106 that corresponds to the given vibration event as will be described.

A vibration event may comprise any one of a number of touch interactions or gestures as mentioned above. In other words, a vibration event may comprise an individual interaction or a plurality of interactions as mentioned above. When a vibration event occurs, the vibration sensor 116 generates a corresponding sample of vibration data. The convolutional neural network 156 is employed to determine a vibration event descriptor based on the sample of vibration data generated by the vibration sensor 116. The sample of vibration data may undergo preprocessing before it is applied to the convolutional neural network 156 as described herein.

The discriminator 159 comprises a neural network that is configured to generate instances of first and second domain values from a corresponding pair of samples of vibration data taken from the pool of vibration samples 163. A contrast loss value is generated from each respective pair of first and second domain values. The contrast loss value comprises a difference in domain loss that is considered. Individual ones of the contrast loss values are inverted and are used to retrain the convolutional neural network 156 as will be described. In this manner, a feature loss difference between feature vectors generated by the convolutional neural network 156 from the pair of samples of vibration data is minimized. In doing so, the contrast loss values are maximized as will be described. A gradient reversal is employed to minimize the feature loss difference and also to maximize the domain loss difference.

The pool of samples of vibration data 163 includes samples of vibration data generated by a population of individuals and samples of vibration data generated by a specific user as will be described. Each sample of vibration data comprises data generated by the vibration sensor 116 (FIG. 1) as described above.

Referring next to FIG. 1.3, shown is an example of the convolutional neural network 156 according to an embodiment of the present disclosure. The convolutional neural network 156 includes a feature extractor portion 173 and a key classifier portion 176.

The feature extractor portion 173 generally comprises the front layers of the convolutional neural network 156 and generate a feature vector S_{V}. The key classifier portion 176 generally comprises the trailing layers of the convolutional neural network 156 that generate the vibration event descriptor mentioned above from the feature vector S_{V}.

During operation, the vibration event utility 153 (FIG. 1.2) receives a sample of vibration data S from a given vibration event from the vibration sensor 116 (FIG. 1.1A). The sample of vibration data S is processed and applied as an input to the convolutional neural network 156. The convolutional neural network 156 generates the feature vector S_{V} internally and ultimately a vibration event descriptor S_{L} is produced as an output. The vibration event descriptor S_{L} indicates the specific touch interaction position 109 or gesture that generated the sample of vibration data S.

Referring next to FIG. 1.4, shown is a flowchart that provides one example of the operation of at least a portion of the vibration event utility 153 according to various embodiments. To this end, the vibration event utility 153 may include further functionality than is described with respect to FIG. 1.4. It is understood that the flowchart of FIG. 1.4 provides merely an example of the many different types of functional arrangements that may be employed to implement the operation of the vibration event utility 153 as described herein. As an alternative, the flowchart of FIG. 1.4 may be viewed as depicting an example of elements of a method implemented in the device 106 (FIG. 1.1A) according to one or more embodiments.

Beginning with box 183, the vibration event utility 153 receives a sample of vibration data S (FIG. 1.3) from the vibration sensor 116. Thereafter, in box 196, the vibration event utility 153 conditions the sample of vibration data S to be processed by the convolutional neural network 156. To this end, the sample of vibration data S to eliminate unwanted frequency components and to ready the sample of the vibration data S to be received as an input to the convolutional neural network 156. Next, in box 189, the sample of vibration data S is input into the convolutional neural network 156.

Then, in box 193, the vibration event utility 153 initiates an action based on the vibration event descriptor S_{L} output from the convolutional neural network 156. The action that is initiated may comprise, for example, an application or function on the device 106. Alternatively, the action initiated may comprise an application or function on a remote device that is in data communication with the device 106. For example, if the device 106 comprises a smart watch, a remote device in data communication with the device 106 may comprise, for example, a smart phone. In another alternative, the smart watch may communicate with a remote computer on the Internet or other network.

Once a desired action is initiated in box 193, the example functionality set forth FIG. 1.4 ends as shown.

Referring next to FIG. 1.5, shown are components that effectively create a domain adversarial neural network (DANN) 203 that employs an unsupervised Siamese adversarial learning approach to retrain the convolutional neural network 156. The DANN 203 includes the convolution neural network 156, the domain discriminator 159, and the pool of vibration samples 163 according to various embodiments of the present disclosure.

The pool of samples of vibration data 163 includes a group of samples S₁-Sₙ that have been generated from many different source domains 203. In respect, as contemplated herein, domain involves the samples generated by a given individual. Given the fact that people will vary in terms of size, shape, strength, and other factors, the samples Sₙ from each domain will reflect the individual qualities of a respective person. Thus, the samples Sₙ have been generated by a relatively large population of individuals to provide for a varied number of samples Sₙ with which to train the convolutional neural network 156.

The samples T₁-Tₙ comprise samples of vibration data 163 generated by a single individual who wears the device 106 (FIG. 1.1A) or upon whom the device 106 is positioned. The samples Tₙ are “unlabeled” in the sense that they are generated by the respective individual during use of the device 106. Also, the samples Sₙ are labeled. In this respect, the vibration event descriptors S_{L} (FIG. 1.3) that are generated from the samples Tₙ are “unlabeled” in that they have not been verified to be correct, where errors may occur.

In one embodiment, respective pairs of samples of vibration data 163, denoted as vibration samples A and B are input into the convolutional neural network 156. The vibration samples A and B are input to the convolutional neural network 156 serially. For each vibration sample A and B, corresponding feature vectors A_{V} and B_{V} are generated by the feature extractor portion 173 of the convolutional neural network 156. Also, the key extractor portion 176 of the convolutional neural network 156 generates corresponding vibration event descriptors A_{L} and B_{L}.

The respective feature vectors A_{V} and B_{V} and the vibration event descriptors A_{L} and B_{L} are then input into the domain discriminator 159. Specifically, the feature vector A_{V} and the vibration event descriptor A_{L} are input into the domain discriminator 159 to produce an identification vector A_{I}, and the feature vector B_{V} and the vibration event descriptor B_{L} are input into the domain discriminator 159 to produce an identification vector B_{I}. A contrast loss L_{d} is calculated as the difference between the respective identification vectors A_{I} and B_{I}.

The contrast loss L_{d} is then used to retrain the domain discriminator 159 by way of contrast loss backpropagation 209. Also, the contrast loss L_{d} is inverted by an inversion function 213 and used to retrain the feature extractor portion 173 of the convolutional neural network 156 as shown. In addition, the vibration event descriptors A_{L} and B_{L} may be employed to generate loss values that are employed to retrain the convolutional neural network 156 by way of classification loss backpropagation 216.

The Siamese adversarial learning approach causes the feature extractor portion 173 of the convolutional neural network 156 to be retrained in a manner that minimizes the difference between the feature vectors A_{V} and B_{V} that belong to the source domains 203 and the target domain 206. To accomplish this, the ratio of the number of samples Sₙ relative to the number of samples Tₙ are specified, for example, such that the samples Sₙ of the source domains 203 make up approximately 90% of the total samples in the pool of samples of vibration data 163, and the samples Tₙ make up approximately 10% of the total samples of vibration data 163 in the pool of samples of vibration data 163. Alternatively, the ratio of the samples Sₙ to the samples Tₙ may be varied to impact the retraining of the convolutional neural network 156 and domain distributor 159 as desired. According to one embodiment, the 90/10 ratio or other ration is specified to cause a minimization of a feature loss difference between respective feature loss values determined from the respective feature loss vectors A_{V} and B_{V}. However, the ratio may be some other ratio such as, for example, 95/5, 94/6, 93/7, 92/8, 91/9, 89/11, 88/12, 87/13, 86/14, 85/15, or some other ratio depending on the desired effect.

The Siamese adversarial learning approach involves Siamese contrastive loss calculations and is employed with an appropriate ratio of samples Sₙ and Tₙ to ultimately retrain the convolutional neural network 156 that determines the vibration event descriptor S_{L} with a success rate above a predefined threshold percentage. In one embodiment, the success rate greater than or equal to 97%. Alternatively, the success rate may comprise some other value such as greater than 96%, 95%, 94%, 93%, 92%, 91%, 90%, or lesser success rate.

Referring next to FIG. 1.6, shown is an example of a networked environment 230 according to an embodiment of the present disclosure. The networked environment 100 includes the device 106 and a server 233 which are in data communication with each other via a network 236.

The network 236 includes, for example, the Internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks. The network 236 may include one or more intermediate devices such as mobile phones or other devices that operate as a node in the network 236.

The server 233 may comprise, for example, a server computer or any other system providing computing capability. Alternatively, the server 233 may represent a plurality of computing devices that may be arranged, for example, in one or more server banks or computer banks or other arrangements. Such computing devices may be located in a single installation or may be distributed among many different geographical locations. For example, the server 233 may represent a plurality of computing devices that together may comprise a hosted computing resource, a grid computing resource and/or any other distributed computing arrangement. In some cases, the server 233 may correspond to an elastic computing resource where the allotted capacity of processing, network, storage, or other computing-related resources may vary over time.

The server 233 includes one or more processor circuits 236 having a processor 243 and a memory 246, both of which are coupled to a local interface 249. The local interface 249 may comprise, for example, a data bus with an accompanying address/control bus or other bus structure as can be appreciated.

Stored in the memory 246 are both data and several components that are executable by the processor 243. In particular, stored in the memory 246 and executable by the processor 225343 are a remote training utility 253, a copy of the convolutional neural network 156 for training, the discriminator 159, and potentially other applications. As set forth above, the convolutional neural network 156 and the discriminator 159 are each part of a domain adversarial neural network (DANN) as is described below. Also stored in the memory 246 are various data elements such as, for example, the pool of samples of vibration data 163 and other data. In addition, an operating system or other operating elements may be stored in the memory 246 and executable by the processor 243 as can be appreciated.

The device 106 is the same as depicted in FIG. 1.2 with the exception that the domain discriminator 159 is removed and target samples of vibration data Tₙ are stored in the memory 146.

During operation, the vibration event utility 153 operates in accordance with the flow chart of FIG. 1.4 in that samples of vibration data Tₙ are generated and stored in the memory 146 as vibration events occur over time during use of the device 106. Also, the vibration event utility 153 tracks the accuracy of the vibration event descriptors S_{L} (FIG. 1.3). If the accuracy falls below a predefined threshold, the vibration event utility 153 sends a copy of the current convolutional neural network 156 to the server for retraining. The remote training utility 253 then orchestrates the training of the copy of the convolutional neural network 156 as was discussed with respect to FIG. 1.5.

The predefined threshold may be specified to be, for example, 97% or other threshold. Ultimately, the predefined threshold may be any number that is deemed acceptable. In one embodiment, the predefined threshold is specified as any number above 90% that is attainable with a convolutional neural network 156 that is trained in accordance with the approaches described herein.

As an additional alternative, a copy of the convolutional neural network 156 may be sent from the device 106 to the server 233 periodically such as every week, every month, every quarter, every year, or any other time period. In this manner, the convolutional neural network 156 may be retrained to maintain accuracy over time as the body of a user of the device 106 changes over time.

### Retraining of the Convolutional Neural Network 156 may Occur Periodically.

Once the copy of the convolutional neural network 156 is fully retrained in the server 233, the remote training utility 253 sends the fully retrained version of the convolutional neural network 156 back to the device 106 where it replaces the previously existing convolutional neural network 156 stored in the memory 146. Thereafter, all samples of vibration data S (FIG. 1.3) generated from vibration events as described above are processed by the newly retrained convolutional neural network 156.

With reference to FIGS. 1.2 and 1.6, it is understood that each of the memories 146 and 246 are defined herein as including both volatile and nonvolatile memory and data storage components. Volatile components are those that do not retain data values upon loss of power. Nonvolatile components are those that retain data upon a loss of power. Thus, each of the memories 146 and 246 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, as contemplated herein, a computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

### Example Embodiment

Robust Finger Interactions with COTS Smartwatches via Unsupervised Siamese Adaptation

### 1 Introduction

Wearable devices like smartwatches and smart wristbands have gained substantial popularity in recent years. However, their small interfaces create inconvenience and limit computing functionality. To fill this gap, we propose ViWatch, which enables robust finger interactions under deployment variations, and relies on a single IMU sensor that is ubiquitous in COTS smartwatches. To this end, we design an unsupervised Siamese adversarial learning method. We built a real-time system on commodity smartwatches and tested it with over one hundred volunteers. Results show that the system accuracy is about 97% over a week. In addition, it is resistant to deployment variations such as different hand shapes, finger activity strengths, and smartwatch positions on the wrist. We also developed a number of mobile applications using our interactive system and conducted a user study where all participants preferred our unsupervised approach to supervised calibration. The demonstration of ViWatch is shown at https://youtu.be/N5-ggvy2qfl.

Recently, wearable devices have gained momentum and witnessed phenomenal growth in popularity. They have become pervasive in the technology industry and are promising computing platforms [77]. Smartwatches and smart wristbands represent the dominant force in the wearable ecosystem, bearing importance among consumers owing to their diverse applications in the industrial sector, healthcare, and consumer electronics, among others. However, by necessity, smartwatches are relatively small compared to traditional computing devices (e.g., laptops and smartphones), on which input technologies cannot be easily replicated due to their size differences. For example, “fat-finger” errors on smartphone screens may not be a significant issue. However, this problem is greatly exaggerated on a smartwatch screen. Inconvenient interaction limits wearable devices' computing functionality: many applications (e.g., SMS messages, manual selecting, and video games) barely usable on smartwatches.

Currently, to overcome the limitations of a small screen, speech recognition is one of the methods but is sensitive to noise levels in the surrounding environments. Moreover, speech input is insecure for sensitive information (e.g., password input) because it is susceptible to eavesdropping. For the same reason, it is also intrusive to the people surrounding the user. Recent works by FingerIO [47] and LLAP [65] achieved millimeter-scale localization accuracy for fingertip tracking, which enables users to write letters on ubiquitous surfaces instead of touch screens. However, both of these papers were implemented for smartphones. Also, writing letters is significantly slower than typing them and still has limited interactions for small devices. [15]

In this paper, we present a novel system termed ViWatch (see FIG. 1.1A), which enables a user to interact with a smartwatch using finger tapping/movement instead of a tiny touch screen. The key premise behind the system is that the user's finger tapping/movement represents a consistent vibration feature, which can be sniffed by the wristband's inertial measurement unit (IMU). The IMU is a standard sensor in all Commercial-Off-The-Shelf (COTS) smartwatches and has low power consumption compared to other sensors in a smartwatch, which are all run by a tiny battery with limited energy. Moreover, the extended finger interface allows users to control the small smartwatch more conveniently. This may unlock a wide variety of upcoming wearable applications previously restricted by a lack of interactive input.

Motivated by this, we design three finger interaction scenarios: dial keyboard, direction keyboard, and one-hand control: FIG. 1/1A maps natural “landmarks” on hands (12 knuckles) into a dial keyboard. Users can use this keyboard to dial numbers and type sentences. FIG. 1.1B has four direction “buttons” on the back of the hand and two “buttons” on the arm. This direction keyboard can control a wide variety of applications, such as playing games or switching menus. FIG. 1.1C shows six one-hand gestures. Users can open the palm or make a first to zoom in and zoom out a car GPS map; swing the palm to the left/right to switch TV channels, music, or slides; pinch three fingers to take a photo and snap the fingers to take a video.

It is nontrivial to embrace the above vision, as the finger interaction system has some subtle deployment variations. For instance, users have different hand shapes. Although these person-to-person variations are relatively small, they may affect the fine-grained finger-level system performance. Even if the classification model can be fine-tuned to a specific user by asking him/her to do some finger tapping and labeling, a user may, however, change the tapping strengths from day to day, and the smartwatch may slip to a different location on the wrist. If we require a user to calibrate the system frequently to meet the variations, it is exhausting and impractical [11]. Can we fine-tune the classification model using unlabeled data generated while users are using the system? By doing so, we eliminate the need to ask users to collect and label data on purpose, but calibrate the system without their involvement.

To this end, we first conducted a preliminary study to understand how variations affect finger interaction. To make the system work under variations, we designed a deep learning model to train a general model with adequate regularization to mitigate over-fitting. We have taken measures to prevent over-fitting, but the accuracy for completely new users (not seen) may still suffer because the training data collected from volunteers is insufficient and does not cover all the data characteristics of every user on earth. Inspired by online learning and domain adaptation, we then utilized an unsupervised domain adversarial neural network to match the embeddings of the unlabeled data with the embeddings of the labeled data from volunteers. Furthermore, we optimized its domain discriminator with Siamese contrastive training so it works for hundreds of domains. Note that some research recently investigated variation problems in IMU signal recognition of large-scale movements such as coarse-grained human activities [7]. However, to the best of our knowledge, there is no work that studies deployment variations for fine-grained finger-level activities, which have a much more subtle difference between activities, thus making it more challenging to adapt to variations. Our studies show that the solutions used for coarse-grained human activity recognition does not work for fine-grained finger interactions.

We built ViWatch as a prototype system for the Android smartwatches. Our implementation achieves real-time finger interaction input with no noticeable latency. We have posted an anonymous demo video on YouTube (https://youtu.be/N5-ggvy2qfl). In this video, we developed several representative exemplar applications using ViWatch as the input surface. ViWatch is also an always available remote for smart glasses, smart TVs, and many other IoT devices. We performed a three-step evaluation to test the performance of ViWatch with 134 volunteers: an offline ablation study, a real-time system evaluation, and a user experience study. The offline study shows that ViWatch outperforms existing methods and improves the model performance significantly on unseen users. A real-time system also demonstrate that ViWatch is resistant to deployment variations, such as different hand shapes, finger activity strengths, and smartwatch positions on the wrist. The results in the user study indicate that ViWatch's unsupervised method is more convenient and user-friendly than supervised adaptation.

To summarize, our main contributions are: To the best of our knowledge, ViWatch is the first system enabling robust finger interactions under deployment variations using unsupervised adaptation through a single IMU sensor in smartwatches. We have designed a novel unsupervised Siamese adversarial deep learning algorithm and built an end-to-end system using commercial smartwatches to achieve real-time finger input without noticeable latency. We have implemented various representative applications using this system. We performed a user study with 134 volunteers and conducted thorough evaluations under various types of interference. Evaluation results show significant performance improvement compared to previous systems.

### 2 Related Work

In this section, we first introduce existing finger interaction systems. Second, we explain state-of-the-art algorithms to overcome domain-shift variation problems in different application tasks. Table 1 shows that ViWatch is the first robust finger interaction in COTS smartwatches using only a single IMU sensor under deployment variations using unsupervised adaptation.

TABLE 1
Related work of ViWatch.

| Methods | ViWatch | [15, 31] | [11] | [74, 77] | [40, 70] |
|---|---|---|---|---|---|
| COTS Smartwatches | ✓ | X | ✓ | ✓ | ✓ |
| Single IMU Sensor | ✓ | X | ✓ | X | ✓ |
| Finger Level | ✓ | ✓ | ✓ | ✓ | X |
| Unsupervised Adaptation | ✓ | X | X | X | X |
| to Variations | | | | | |

### 2.1 Finger Interactions

Finger interaction is essential for wearable devices. A variety of approaches allow finger interaction by designing new skin-worn hardware [26, 31, 32, 34, 38, 48, 60, 66, 69, 75, 75]. There are many different techniques, e.g., electronic signatures [44, 51, 78], vibrations and sounds [9, 10, 13, 14, 16-21, 25, 31, 35, 37, 46, 68], and even optical projections [30, 41]. SkinButtons [41] proposes using several tiny projectors embedded into the smartwatch to render icons on the skin. iSkin [66] proposes a thin sensor overlay with biocompatible materials for touch input on the body. SkinTrack [78] leverages a ring to emit RF signals and measures the phase differences of received signals to track the finger. SkinMarks [67] designs conformal on-skin sensors for precisely localized input and output on fine body landmarks. WatchSense [59] utilizes a depth sensor for on-skin input, which is usually not available on the commodity smartwatch. Some research [15, 31] classifies the tapping with machine learning algorithms using tapping-induced vibrations. For example, Skinput [31] appropriates the human body for bio-acoustic transmission, enabling the skin to be an input surface with an arm-worn sensor-array. ViType [15] customizes a single vibration sensor and employs a fully connected neural network to distinguish different finger tapping induced vibrations. The aforementioned approaches, however, require dedicated hardware and have limited deployment capability.

There are some works using smartwatches for human activity [6, 8], hand location [27, 49], gesture [5, 40, 42, 43, 53, 55, 76] or finger [45] classification. Most recently, some research [74, 77] achieved finger-tapping interaction with commercial smartwatches. For example, iDial [77] and Tapskin [74] use microphones and the IMU in a smartwatch to classify different finger tapping induced sound with a Support Vector Machine (SVM) as the classifier. However, the microphone is sensitive to acoustic noise. AcouDigits [81] used ultrasonic sensors to track fingers on the skin, but it was energy-intensive. The most related recent works are Taprint [11] and [70]. [70] enabled users to customize hand gestures through supervised learning. Taprint [11] mainly focus on security and authentication using finger activities. While Taprint [11] also offers keyboard input, it requires users to collect and label more data every time they change their tapping behaviors. In contrast, ViWatch utilizes unsupervised Siamese adversarial training and does not necessitate users to label any additional data.

Overall, ViWatch only uses a single IMU sensor in COTS smartwatches to classify finger interactions without instrumenting any dedicated sensors, thus being more efficient and accessible. Most importantly, this is the first work making a novel contribution to robust finger interaction systems under deployment variations via unsupervised Siamese learning.

### 2.2 Battling Variations

As methods to overcome the problem of data in different domains, Siamese networks, generative networks, transfer learning, and domain adversarial training have been applied. TouchPass [71] has used Siamese networks to achieve behavior-irrelevant on-touch user authentication. Generative adversarial networks (GANs [56]) have been successfully introduced to sensor-based human activity recognition [72]. Additionally, GANs have been used to augment biosignals [28] and in IoT [72]. Extending the conventional GAN approach, in [52], a data augmentation technique for time series data with irregular sampling is proposed utilizing conditional GANs. Transfer learning has been demonstrated to be useful in activities recognition [22], localization [50], crowdsourced mobile activity learning [80], and human activity recognition (HAR) [64]. Previous studies use transfer learning to translate training data, features, or fine-tuning models for mobile sensor data. Rey et al. [54] discussed the case that the new domain just happened to contain the old one. Hu et al. [33] developed a bridge between the activities in two domains by learning a similarity function via Web search for HAR. ViFin [12] fine-tuned finger writing data of target users from source users. However, it requires target users to provide labeled data, thus it is exhaustive and user unfriendly. In contrast, ViWatch uses unlabeled data in the target domain from users' daily usage.

Our work is related to domain adversarial training approaches [62, 63, 79]. [23] is the first domain adversarial training approach proposed to tackle the unsupervised domain adaptation problem. Zhao et al. [79] propose a conditional adversarial architecture to retain the information relevant to the predictive task when removing the domain-specific information. Although this architecture is effective, it does not consider suppressing the domain shift further with unlabeled data. Besides, most of the domain adversarial learning solutions have only been used in image classification [24, 57] or large-scale movements such as coarse-grained human activities [7, 29].

However, there is no work that studies deployment variations for fine-grained finger interactions. Fine-grained finger interactions have a much more subtle difference between activities, thus making it more challenging to adapt to variations. Our studies show that the solutions used for coarse-grained human activity recognition do not work for fine-grained finger interactions. To the best of our knowledge, no work so far has designed a novel unsupervised Siamese adversarial learning for finger interaction and this work is the first to do so.

### 3 Preliminary Study

In this section, we first explain why tapping on different locations on the hand is distinguishable and discuss the physical phenomenon and insights of vibration-based finger tapping systems. (Section 3.1) Then, in Section 3.2, we build a mathematical model to analyze how variations (tapping strengths, sensor positions, and hand shapes) affect the recognition performance. Then we conduct experiments to further prove that deployment variations lead to corruption of finger interaction system performance in section 3.3. The experiments show that it is vital to achieve a robust finger interaction under deployment variations.

### 3.1 Vibration Dispersion

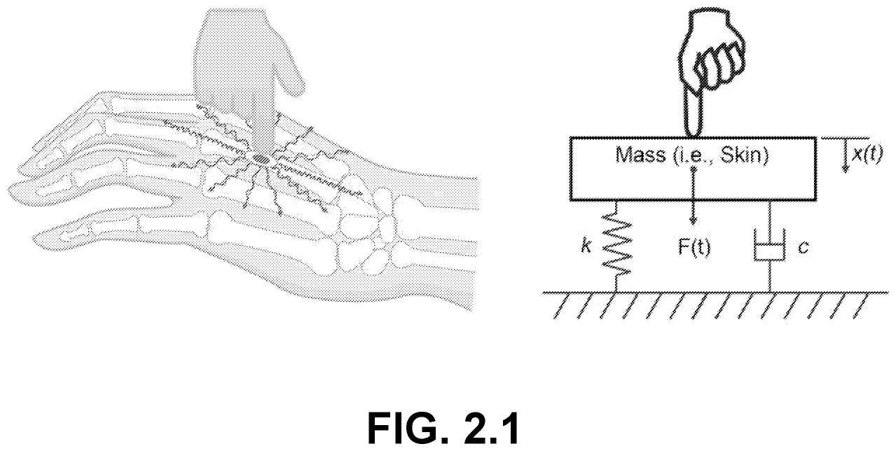

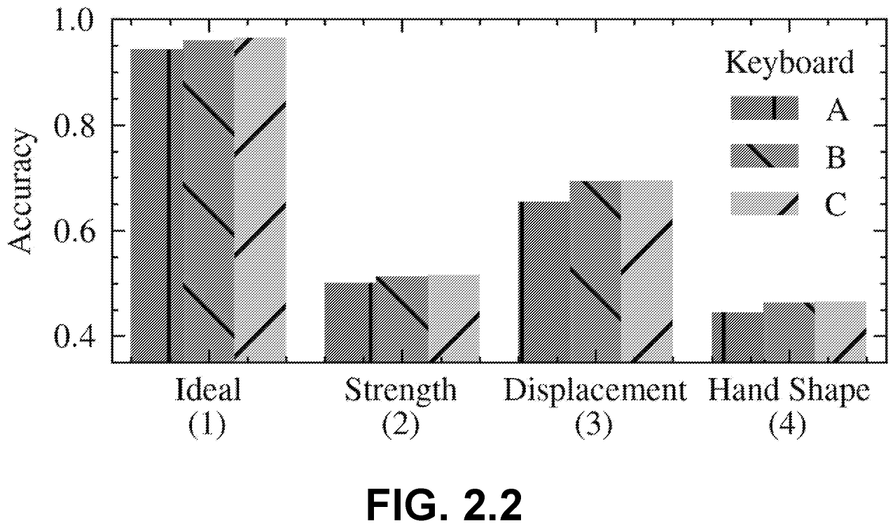

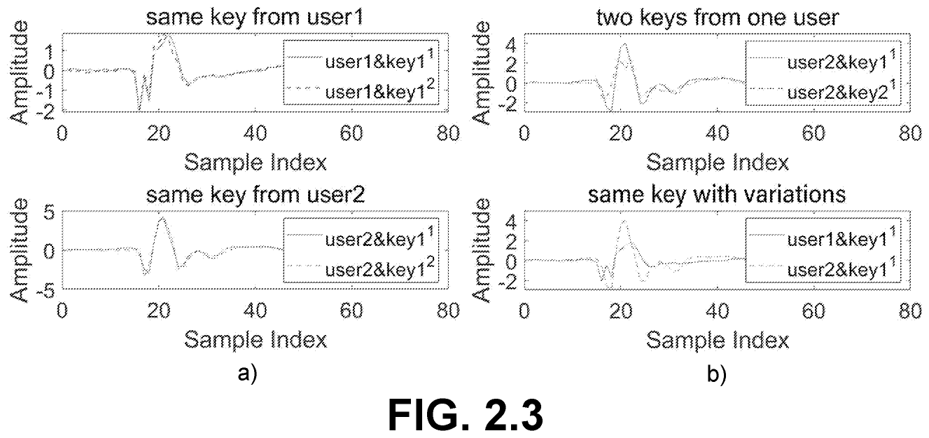

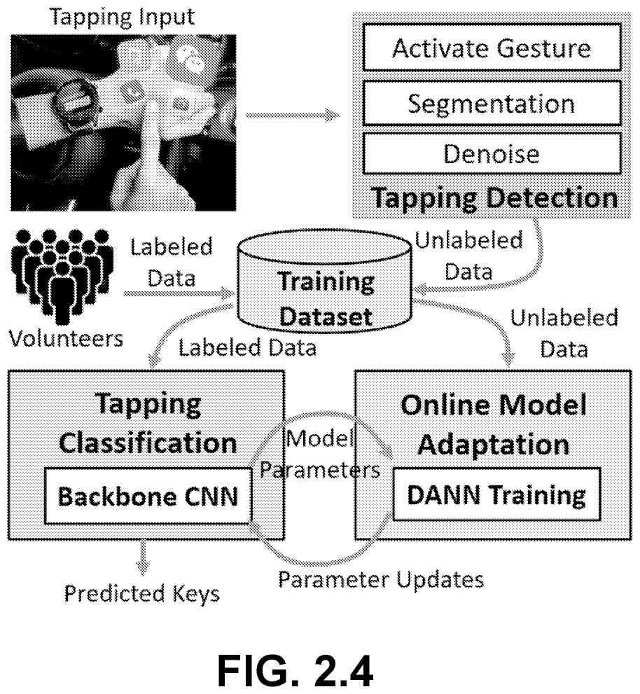

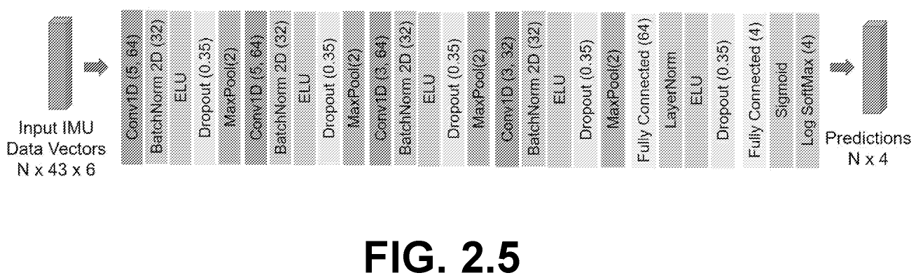

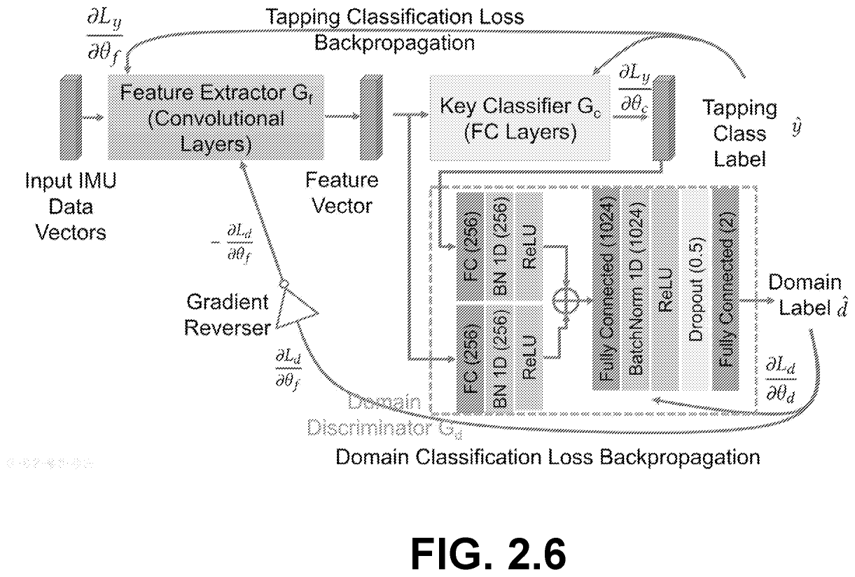

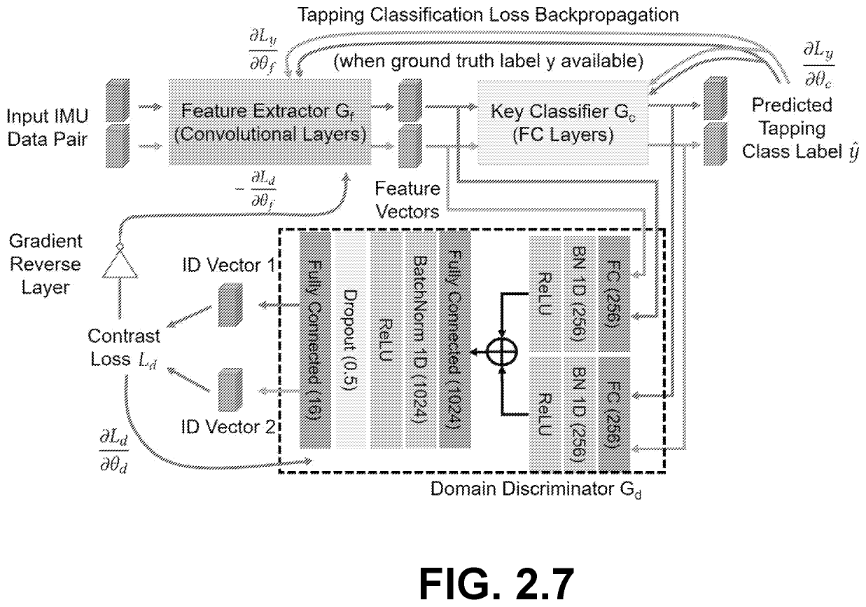

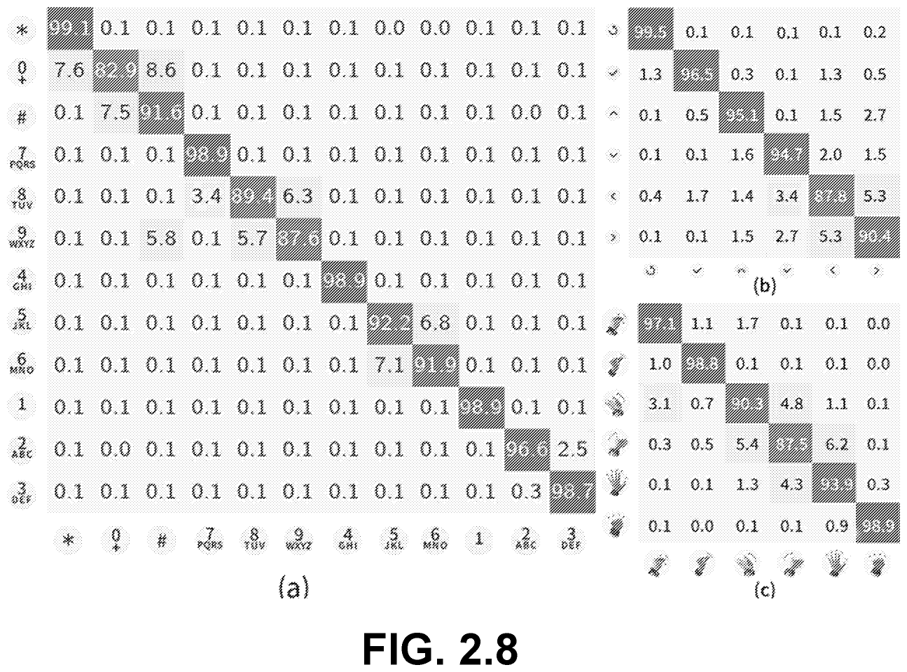

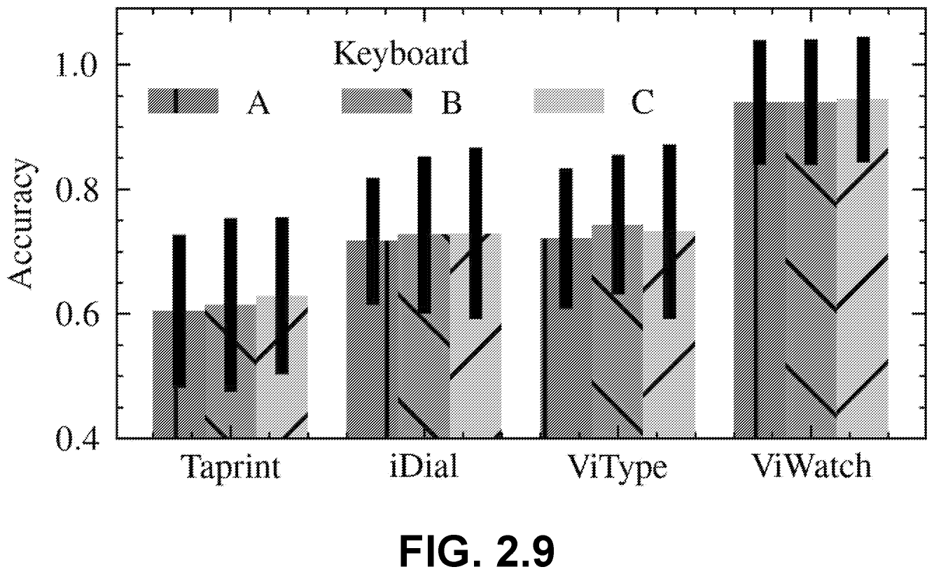

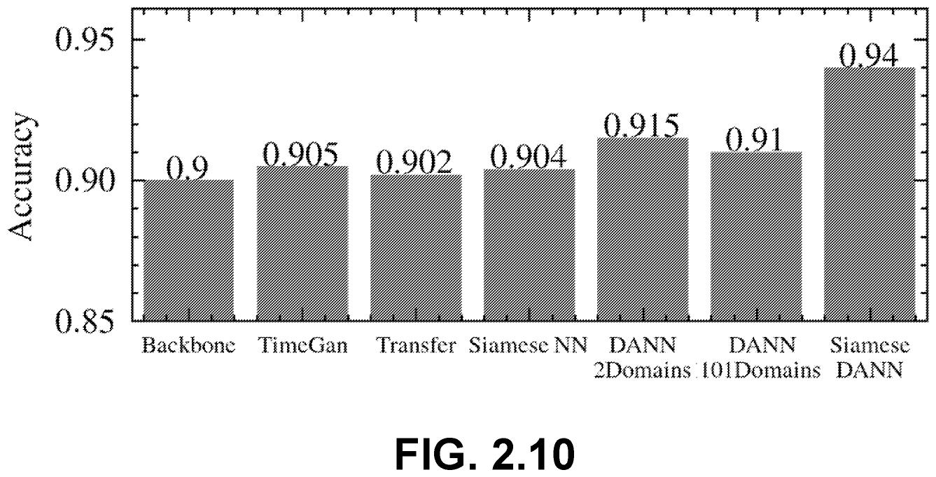

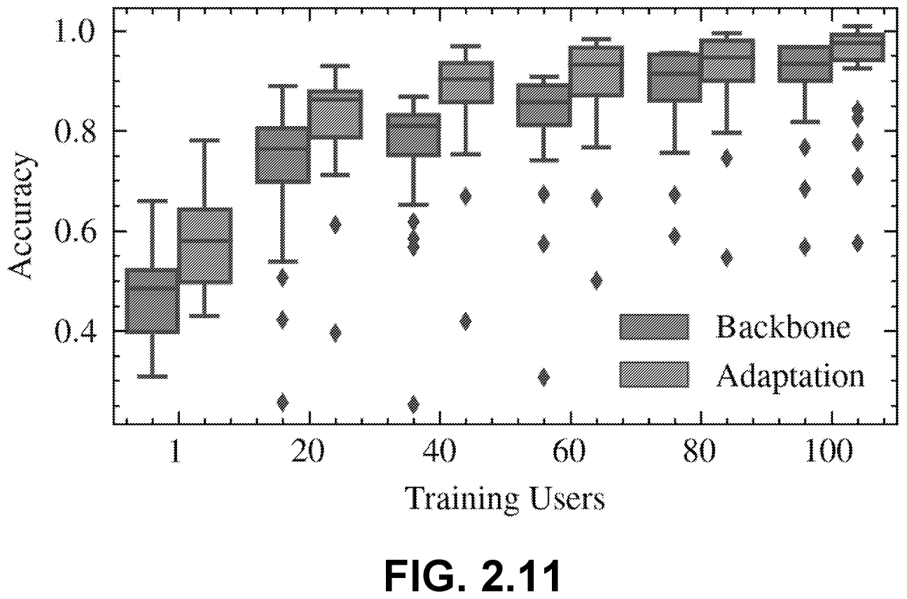

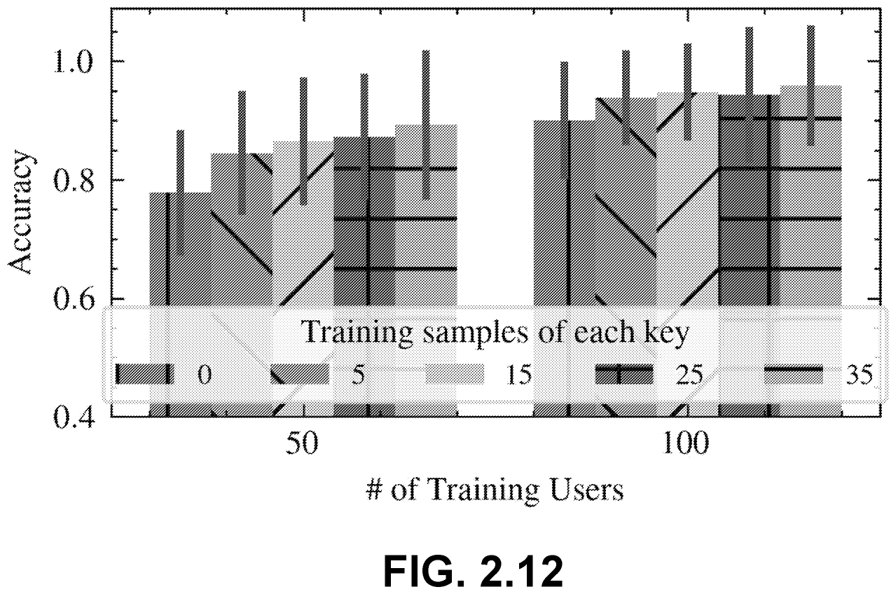

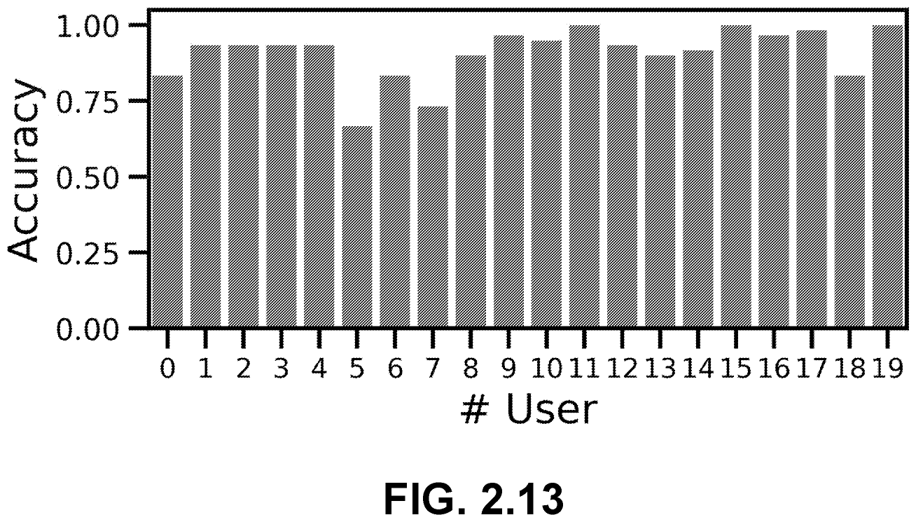

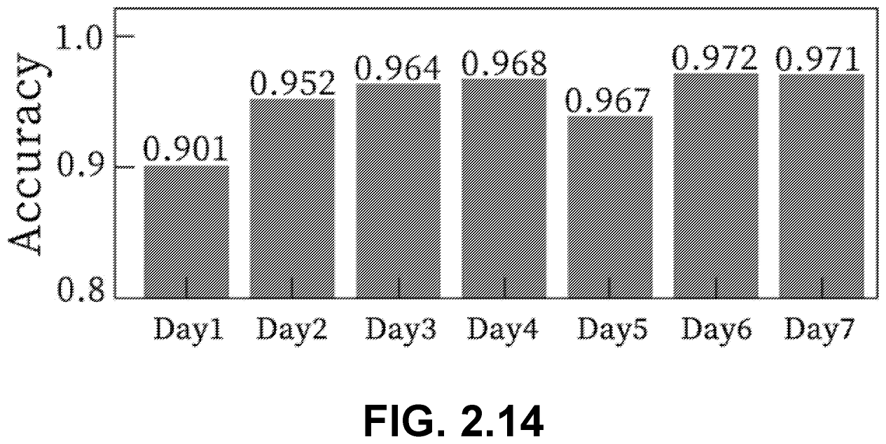

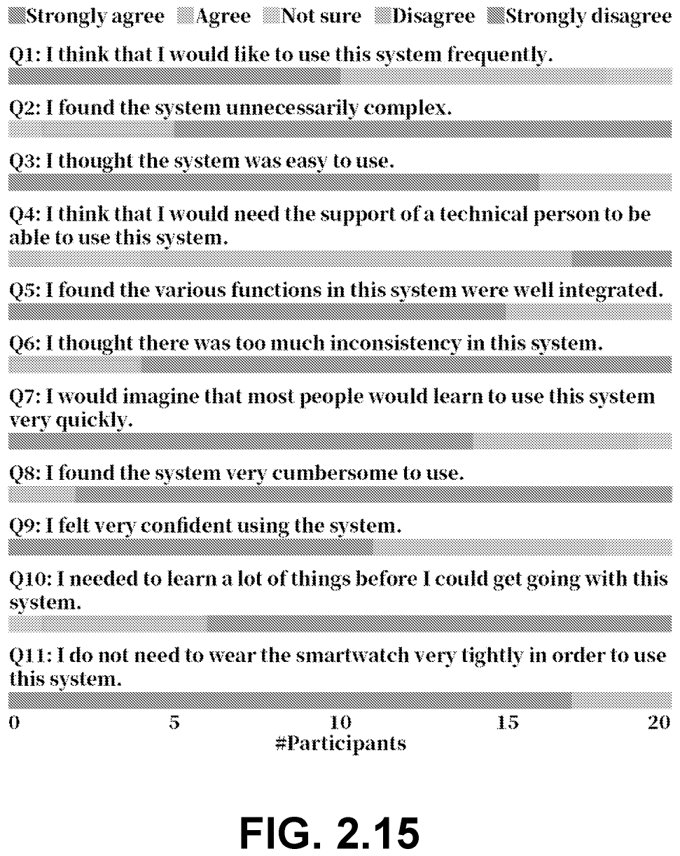

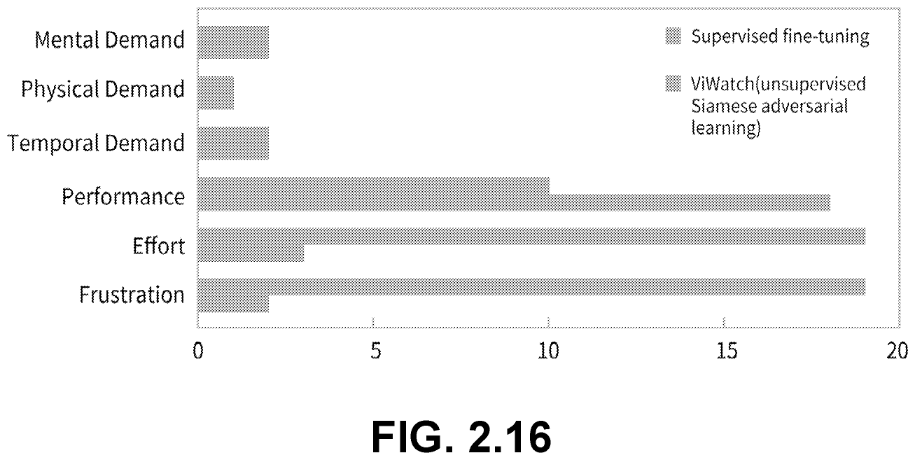

The pivotal physical phenomenon for IMU-based on-body tapping recognition is vibration dispersion. When the back of the hand is tapped (FIG. 2.1), it results in vibrations of diverse frequencies, traveling through multiple paths to the IMU sensor in the smartwatch. Owing to vibration dispersion, the arrival time discrepancy between distinct frequency components expands with increasing propagation distance. Moreover, higher frequencies preferentially propagate through bone over soft tissue, enabling energy transmission over greater distances [15]. The intricate hand structure further amplifies vibration dispersion. These frequency components, post multi-path propagation, interfere to generate unique vibration profiles at various hand locations.

### 3.2 Mathematical Modeling Analysis

To comprehend how deployment variations influence vibration-based finger tapping systems, we devise a mathematical model. Given the intractability of mathematically modelling complex vibration systems such as the human body, we initiate a single-degree-of-freedom model depicted in FIG. 2.1 to articulate basic principles. In this model, a tapping point incorporates a mass element (a rigid body with a constant mass m), a spring element (defined by constant k), and a damping element (denoted by a damper with damping coefficient c) [11].

The application of external force to the rigid body leads to vertical displacements. As per Newton's second law of motion, we have,

$$F ( t ) = ma ( t ) + kx ( t ) + cv ( t ) , \qquad ( 1 )$$

where F(t) denotes the external force, v(t) the velocity, x(t) the vertical displacement, c the damping coefficient, k the spring constant, and m the mass. This relation can be further expressed as,

$$F ( t ) = m \frac{{d}^{2} x ( t )}{{dt}^{2}} + kx ( t ) + c \frac{dx ( t )}{dt} . \qquad ( 2 )$$

A finger tapping vibration has two phases. The first phase involves quick contact between the finger and the rigid body, viewed as forced vibration with a constant force F(0). Post the initial transient disturbance, we enter the second phase: free vibration, where the system vibrates independently after finger-body contact ceases.

In the forced vibration phase, applying the Fourier transform to both sides of (2), we get,

$$\frac{F ( 0 )}{jw} ( 1 - {e}^{- jw Δ t} ) = - {w}^{2} mX ( w ) + kX ( w ) + jwcX ( w ) , \qquad ( 3 )$$

yielding,

$$X ( w ) = \frac{1 - {e}^{- jw Δ t}}{- \frac{jm}{F ( 0 )} {w}^{3} - \frac{c}{F ( 0 )} {w}^{2} + \frac{jk}{F ( 0 )} w} , \qquad ( 4 )$$

where X(w) is the spectrum of the vertical vibration signal, and w the vibration frequency at the tapped position.

Next, we examine the horizontal vibration during the free vibration phase. As vibration signals propagate horizontally from the tapping location to the smartwatch, they undergo attenuation. This attenuation, modeled as a constant e^{-αd} in [15], where d is the propagation distance and α the attenuation coefficient, allows us to derive the vertical vibration signal at the smartwatch location as,

$$Y ( w ) = \frac{( 1 - {e}^{- jw Δ t} ) {e}^{- α d}}{- \frac{jm}{F ( 0 )} {w}^{3} - \frac{c}{F ( 0 )} {w}^{2} + \frac{jk}{F ( 0 )} w} . \qquad ( 5 )$$

Despite unique patterns generated by tapping at various locations due to vibration dispersion, equation (5) highlights several parameters (variations) impacting this phenomenon. For instance, varying hand shapes affect m, c, and k [58], tapping strength alters F(0), and smartwatch position changes d. This explains why finger-tapping vibration recognition performance is disrupted under these variations.

### 3.3 Investigative Experiments

To ascertain the extent to which deployment variations impact system performance, we conducted experiments with five participants, comprising two females, each with differing hand shapes. The smartwatch was worn comfortably on the left wrist, and the hand was kept suspended in the air. Each participant was first asked to randomly tap keys according to the keyboards in FIG. 1.1A, delivering 40 taps per key. The data collated in this step constitutes the “anchor dataset”. Subsequently, the experiment was repeated with stronger tapping strength and after repositioning the smartwatch by a 2 cm displacement.

To analyze model accuracy for the anchor dataset, we partitioned samples from each key/gesture into a 3:1:1 ratio for the training, validation, and test sets, respectively. Individual fully connected neural network models were trained for each participant. As indicated in FIG. 2.2 item (1), the average accuracy was a robust 95% across three keyboards. Yet, when models were trained on the anchor dataset and tested on the stronger tapping strength dataset, the average accuracy fell to 50%, as depicted in FIG. 2.2 item (2). Analogously, models trained with the anchor dataset but tested with a dataset after a 2 cm smartwatch displacement recorded an average accuracy of only 69% across the three keyboards, as shown in FIG. 2.2 item (3). A general model trained across different users (hand shapes) yielded a leave-one-participant-out (LOO) accuracy of merely 45%, as in FIG. 2.2 item (4). This poorer accuracy highlights the complexities added by varying hand shapes, tapping strengths, and smartwatch positions. In essence, variations in tapping strength, smartwatch placement, and hand shapes significantly affect system performance.

Examination of the signal profile in the time domain, via plotting the Z-axis accelerometer vibration signals from a typical smartwatch (FIG. 2.3), reveals consistency in vibration waveforms from the same key (FIG. 2.3 item (a)). While two different keys from one person produce distinct waveforms (FIG. 2.3 item (b), upper part), waveform differences arise between two users even for the same key (FIG. 2.3 item (b), lower part). This variability is observable between any samples with variations.

These investigative experiments highlight that, despite consistent vibrations from tapping the same key, person-to-person variations (hand shapes, tapping strengths, smartwatch positions) significantly degrade overall performance. Therefore, it is crucial to develop a classification model capable of distinguishing between finger interactions while maintaining robustness against these variations.

### 4 ViWatch

In the preliminary experiments described in Sec. 3, we observe that the deployment variations affect the system performance significantly. An ideal classification model should be able to discriminate the difference between finger activities and be resistant (above 95% accuracy) to variations. In this section, we describe our design of the robust finger interaction system under deployment variations.

Our design is elaborated in the following steps as shown in FIG. 2.4: We first pre-processed the vibration signals. (Sec. 4.1) Then, we designed a CNN-based deep learning model to train a general model with adequate regularization to mitigate over-fitting. (Sec. 4.2) Although we have taken measures to combat overfitting, the accuracy for completely new (unseen) users still suffers due to the fact that the training data from volunteers is insufficient and does not cover every user's data characteristics on earth. Our idea is to improve the model continuously by using the data generated by users' daily use in an unnoticeable way, based on online learning and domain adaptation. However, these daily generated data have no labels. Thus, we utilize an unsupervised domain adversarial neural network (DANN) to match those variations (Sec. 4.3). Unfortunately, it is impractical to separate hundreds of domains with cross-entropy loss. To address this problem, we optimized its domain discriminator with Siamese contrastive training (Sec. 4.4). With these steps, we achieve a robust finger interaction with COTS smartwatches under deployment variations.

### 4.1 Signal Pre-Processing

ViWatch uses energy-based double thresholds segmentation [15] to capture the tapping-induced vibrations. When the signal energy is higher than the thresholds, the time is defined as the point at which the tapping vibration starts. In terms of the segment ending point, we set it to 0.5s after the starting point. This is because the duration of signals in this application is usually around this value based on our observations. Human mobility such as walking often causes body vibration, which needs to be denoised. Based on the short time Fourier analysis, we observe that the vibration caused by human mobility is mostly less than 10 Hz. Therefore, a 20 Hz Butterworth high pass filter is sufficient to remove noise from the captured vibration signal. Through this filter, the direct current component such as gravity can also be removed. In the finger movement input process, the users need to turn on the touchscreen first and start the finger interaction input with an activate gesture [12]. When a user types on a laptop keyboard or washes dishes, he/she may not turn on the touchscreen of the smartwatch. However, in the text input process, some actions when typing on the back of one's hand (e.g., scratching hands or picking up objects) may trigger false positives. We used SNR based threshold [11] to remove the noise. Afterwards, ViWatch normalizes the magnitude of signals using the Z-score normalization technique, and aligns signals by finding the TDOA (Time Difference of Arrival) with the GCC (Generalized Cross-Correlation) algorithm [39]. Last but not the least, ViWatch extracts weighted features based on position-related points with Fisher score selection.[11]

### 4.2 Backbone Model

A few pioneer works have explored the problem of classifying finger tapping. They have proposed using Support Vector Machines (SVM) [74, 77], k-Nearest Neighbor (kNN) [11], and fully connected neural networks (ANN) as classifiers to distinguish different keys. While the aforementioned methods achieved success in their application scenarios, those models are optimized for a single user under restricted conditions. For a broad-scale deployment, it is not practical to collect large amounts of labeled training data from a single user. Also, these models fail to meet expectations during real-world deployments: system performance significantly degrades due to deployment variations, such as hand shapes, tapping forces, and device positions.

With the collection of a larger dataset that contains large amount of data contributors, we propose using a Convolutional Neural Network (CNN) as the backbone model of ViWatch, whose structure is shown in FIG. 2.5. We name it “backbone” as the following model design will be built on top of it. Here we provide an intuition of the model structure design: While the model needs to be sufficiently complicated in order to capture the dynamics of tapping behaviors of a large population, over parameterization could lead to significant over-fitting that downgrades the model's testing performance. Guided by the trade-off mentioned above, the proposed backbone CNN consists of five consecutive convolutional blocks and three fully connected blocks. We employ batch normalization within each block to speed up the training as well as to provide the regularization that reduces over-fitting [36]. We determine that additional dropout layers are not necessary after some ablation studies. The input to this CNN structure has dimensions of N×43×6, where N is the batch size, 43 are the timesteps, and 6 are the IMU data axes. The output is a multi-class one-hot prediction.

### 4.3 Unsupervised Adaptation

In the previous section, we discussed our efforts on training a backbone model, which aims to create an “average” model for all users. However, the model is only as good as its training data. If the labeled training dataset fails to cover a considerable diversity in the population, the model trained on it may encounter generalization difficulties and have poor accuracy for a new (unseen) user. One of the most intuitive model adaptation methods is to collect a small labeled dataset from the end user and fine-tune the model parameters to cater to user habits. However, users need to frequently label more data every time they change the tapping behaviors. Unfortunately, this method increases the burden on the product users, and users are often reluctant to follow complicated instructions to collect their own label dataset [11]. However, we notice that the user's daily usage of ViWatch will generate abundant unlabeled data. Can our model adaptation process benefit from unlabeled data of the target user?

To address this question, we apply unsupervised domain adversarial training of neural networks (DANN) [24]. The high-level intuition is that DANN has two neural networks. It has a discriminator to identify different users and another classifier to classify different finger activities. The two models are trained together in a zero-sum game, adversarial. Then it reverses the gradient of the discriminator so that DANN ONLY classifies different finger activities but can NOT identify different users. In this way, the final layer only has finger activity patterns while no variations.

We provide a more detailed description of our user-dependent model adaptation architecture in FIG. 2.6. This architecture consists of three major components. The feature extractor G_{f} and the key classifier G_{c} are just the early and late layers of our backbone CNN model discussed in Section 4.2. The third component is a domain discriminator G_{d}. The features extracted from G_{f} are used by G_{c} to classify the tapping keys. The features, along with the classification results, are also used by the domain discriminator G_{d} to determine if a feature vector comes from the source domain or the target domain. The three components form a structure similar to a generative adversarial network (GAN), whose expected behavior is to maximize the tapping key classification accuracy and minimize the accuracy of domain classification.

In FIG. 2.6, direct arrows indicate the forward pass, and curved arrows indicate the back propagation pass. During the training time, we first split the whole smartwatch tapping dataset into a training set Sₜᵣₐᵢₙ, a validation set S_{valid}, and a left-out user. Here all the data in Sₜᵣₐᵢₙ form the source domain, and the data from the left-out user form the target domain. In the target domain, we select a part of the data and remove their labels to use them as the unlabeled training data Tₜᵣₐᵢₙ. The rest data of the left-out user is used to test the model performance, and we denote them with Tₜₑₛₜ.

In the forward pass, all the data entries in Sₜᵣₐᵢₙ and Tₜᵣₐᵢₙ are input to the DANN network. For each data entry, we obtain a tapping key prediction ŷ. and a domain prediction \hat{d}. The loss consists of three parts: the key classification loss

$${L}_{y}^{source}$$

for Sₜᵣₐᵢₙ only (target domain data have no labels), the domain classification loss

$${L}_{d}^{source} and {L}_{d}^{target}$$

for Sₜᵣₐᵢₙ and Tₜᵣₐᵢₙ separately. Then the three modules are trained jointly using back propagation as depicted in FIG. 2.6. When the gradient is passed from G_{d} to G_{f}, a gradient reverse layer is applied to change the symbol of the gradients. Here we provide some intuition about the gradient reverse layer: By design, G_{f} should maximally support G_{c} while deceiving G_{d}. In other words, we want the extracted features to be domain-agnostic. Thus a bad performance of the domain discriminator should be desired for the feature extractor G_{f}. Note that no gradient is passed from the domain discriminator G_{d} to the key classifier G_{c}. Finally, the optimization problem can be written as

$${min}_{{θ}_{f} , {θ}_{c}} {max L}_{{θ}_{d}} = {L}_{y}^{source} - α ( {L}_{d}^{source} + λ {L}_{d}^{target} ) , \qquad ( 6 )$$

where θ_{f}, θ_{c}, and θ_{d} are the parameters of the feature extractor, key classifier, and domain discriminator, respectively. We evaluate the adapted model (only G_{f}+G_{c}) performance on target domain test data Tₜₑₛₜ.

Using the domain adversarial training introduced in this section, we provide a better user experience for the target user by adapting the backbone model to the target user's habits. During real-world deployments, the Tₜᵣₐᵢₙ should be the unlabeled data generated from the daily usage of ViWatch. If the user allows, the daily unlabeled tapping data will be collected and uploaded. The backbone model parameter is then adapted and pushed back to the smartwatches as application updates once DANN training is finished.

### 4.4 Siamese Optimization of DANN

The previous section introduced how we employ DANN to address variations of finger interactions. In our experiments, we found that the proposed DANN performance gain is limited. First, we re-examine the intuition of applying DANN to solve the variation problem in sensor data classifications: the DANN method aims to match the embeddings of the unlabeled new data (target domain) with the embeddings of the training data (source domain). This setting is optimal if the source data is collected from one environment and the target data is collected from another environment. However, in our settings, all the user data in the training set form the source domain, and the unlabeled data from one new user form the target domain. In other words, the target domain is the data distribution from a single user, while the source domain distribution is drawn from a mixture of hundreds of users. This skewness in domain definition might make the domain matching problem more difficult.

An intuitive thought to solve this domain skewness problem will be to assign one domain to each user in the training set, which will convert the task of domain discriminator G_{d} from binary classification to multi-class classification. However, this task is too difficult for G_{d}, since the number of classes (e.g. hundreds of users) grows linearly with the training dataset size, and the decision boundary is exceptionally complicated. Luckily, we realize that we do not need to identify hundreds or thousands of users; in contrast, we only need to know if a sample is from the same user or from different users. Therefore, we modify the DANN and optimize its domain discriminator with Siamese contrastive training.

The updated Siamese-DANN structure is shown in FIG. 2.7. Specifically, we change the final layer of the domain discriminator G_{d} to a fixed embedding consists of 16 nodes and remove the softmax layer used for classification. During the DANN training, the tapping classification loss L_{y} is calculated and back-propagated exactly the same as Sec 4.3 when the input data are labeled. The domain loss L_{d}, on the other hand, is calculated as follows: first, from each training batch, we randomly sample pairs of data from the union of the training set Sₜᵣₐᵢₙ and the target user data Tₜᵣₐᵢₙ. If the two tapping data come from the same user, the pair is labeled as a positive pair (d=1). Meanwhile, a pair with samples from different users will be labeled as negative (d=0). We make sure that the positive and negative pairs are balanced, and at least half of the Tₜᵣₐᵢₙ data (from the target user) is used once in this generation. Secondly, we feed the two time series in each pair to our model separately, and at the output of the domain discriminator G_{d} we will get two 16-dimension embeddings. Intuitively, for a model that recognizes each user, if it is a positive pair (time series of the same user), we want to encourage their embeddings to be close to each other. Otherwise we want their distance to be farther than a threshold. The final resulting contrastive loss is given by

$${{L}_{d} = d \cdot ‖ f ( {x}_{1} ) - f ( {x}_{2} ) ) ‖}_{2} + \qquad ( 7 )$$

$${( 1 - d ) \cdot max ( 0 , δ - ‖ f ( {x}_{1} ) - f ( {x}_{2} ) ) ‖}_{2} ) , \qquad ( 8 )$$

where f( ) is the Feature Extractor G_{f}, d=1 for positive pairs, δ is the threshold, and the embedding distance is measured with the L2 norm. The other parts like the gradient reverser layer and parameter updates are all the same as in Sec. 4.3.

### 5 System Implementation

We have implemented ViWatch as a standalone application program on a commodity Android smartwatch, the Huawei Watch 2 (with a 1.2 GHZ Quad-Core processor and a RAM with 512 MB). Vi-Watch utilizes the built-in accelerometer and gyroscope (InvenSense MPU6515) and acquires the motion readings through existing Android Wear APIs to detect the finger tapping induced vibrations. The sampling rate through the APIs is 100 Hz. We trained the neural network models using Pytorch 1.5.1 on a desktop computer which has AMD Ryzen 7 2700X Processors and an NVIDIA TITAN X Graphics Card. PyTorch supports an end-to-end workflow from Python model training to Android model deployment (via the PyTorch Android API [61]). After training the model, we implement all the components of our system including signal processing and neural network classification on a COTS smartwatch to classify the finger interactions in real-time. To collect users' unlabeled data during daily usage for updating models, we used network socket with IP addresses to send collected data from the smartwatch to the server and send back updated models to the smartwatch. And we also built some representative applications on the smartwatch using ViWatch (see section 7.3.1).

In the training process, the feature extractor G_{f} and the key classifier G_{c} (CNN backbone) are pre-trained on Sₜᵣₐᵢₙ for 600 epochs. The training is stopped early if the validation accuracy is greater than 50%. For each test user, the DANN training goes on for 33 epochs. Similar to the backbone model training, we use early stopping, where the model with the best performance on the source domain validation set S_{valid} is saved. For the current implementation, the average end-to-end latency is 0.2 seconds from tapping to the output display. The initial backbone general model training process (100 participants' data) in the server takes about 109 seconds on average for each keyboard. The DANN model update process takes 44.5 seconds per user (with 30 unlabeled samples for each key). So the DANN adaptation is scalable with more users and more unlabeled data.

We measure the power consumption of the smartwatch using “Battery Historian” from Google. Specifically, We measured three states: (1) idle with the display on, (2) ViWatch with power on, but without tapping input, and (3) ViWatch with power on and continuous tapping. Since the platform can only measure the percentage of the battery consumption, we record the time duration for consuming 1% of the battery for each state. Each state's average resulting time duration is 215 s, 190 s, 178 s, respectively. Given the battery capacity and the working voltage, we calculate the average resulting power consumption of each state, which is 247 mW, 284 mW, 298 mW, respectively. Thus, ViWatch only consumes an additional 51 mW of power on top of the base power consumption. For comparison, we also conduct the measurement when running a pedometer application, resulting in the power consumption of 288 mW. Thus, the power consumption of ViWatch is similar to the typical application running on a smartwatch.

### 6 Experimental Setup

We conducted three primary experiments for evaluations. The smartwatch is worn on the left wrist in a comfortable manner with the hand in the air. Unless otherwise specified, all the experiments are launched based on the default setting discussed as follows. The study was approved by the Institutional Review Board (IRB-SBS 4166).

1) Offline dataset: We recruited 114 participants (46 of them are female) in the age range between [18, 51]. Their body mass indexes (BMIs) range from 19.12 (lean) to 29.58 (obese). To demonstrate the basic performance of ViWatch, all participants were asked to tap on three keyboards as shown in FIG. 1.1A randomly to generate the basic offline dataset (with 114 participants×24 keys×40 times=109440 samples in total). (For easier explanation, we use “key” to refer to both “location” and “gesture”). Participants are allowed to tap casually with any posture and strength. The performance of this dataset is evaluated in the following Section 7.1 “Offline Evaluations”.

2) Real-time test set: Then we recruited an additional 20 participants to use these three keyboards in real time under different conditions (see section 7.2). These participants are in the age range between [18, 42]. Their body mass indexes (BMIs) range from 17.63 (lean) to 28.12 (obese). Before using ViWatch, the user was given a 10-minute warm-up period to get familiar with the system. For each condition, participants were asked to tap 120 random keys we provided as a test set for three keyboards separately. The results of these experiments are presented in Section 7.2 “Real-time Evaluation”.

3) User study: We also asked these 20 participants to try various applications we developed using ViWatch (10 minutes for each application) and fill out questionnaires to present their user experiences. (see Section 7.3)

### 7 Evaluation

In this section, we first study the performance of ViWatch comparing to State of the Art (SOTA) methods on the offline dataset from 114 volunteers in Section 7.1. We further perform real-time experiments in which an additional 20 new volunteers produce unlabeled data during daily usage in one week. In the real-time experiments (Section 7.2), we investigate how Siamese adversarial learning improves accuracy over time and against different variations. Third, we evaluate ViWatch's usability and workload based on the standard System Usability Scale (SUS) and NASA Task Load Index (NASA-TLX) to compare to the supervised calibration in Section 7.3.

### 7.1 Offline Evaluations

In this section, we evaluated ViWatch performance on an offline dataset collected from 114 users. In order to understand the effectiveness of different techniques and fairly compare different methods, we conduct a leave-one-out evaluation during all the experiments. One of the users is left out to be the new user (target domain). The target domain data is then split into Tₜᵣₐᵢₙ (label-removed, for DANN training) and Tₜₑₛₜ (for system performance evaluation). No matter which keyboard setting we are using, each user has 40 trials for each tapping key. By default, 30 of them will go to Tₜᵣₐᵢₙ, and 10 will go to Tₜₑₛₜ unless otherwise specified. The rest of the 113 users form the training set Sₜᵣₐᵢₙ (100 users) and the validation subset S_{valid} (13 users). This process is repeated for all 114 users, and the average accuracy is reported. To ensure a fair comparison and reproducibility, we repeat all the experiments with random seeds 0, 100, 200, 300, and 400 and take an average.

7.1.1 Evaluation of ViWatch compared to SOTA. First, we evaluated the ViWatch model we proposed. FIG. 2.8 shows the LOO accuracy of the confusion matrix for the three keyboards. The average accuracy of keyboards A, B and C are 93.89%, 93.99%, and 94.40%, respectively. We observed that the closer locations lead to lower accuracy (e.g., Key “0” and Key “#”).

We also compared ViWatch to existing finger interaction methods proposed in previous works, including ViType (a fully connected neural network) [15], iDial (SVM) [77], and Taprint (kNN) [11]. Laput, etc. [40] also used a fully connected neural network to classify fine-grained hand activities.

As shown in FIG. 2.9, the results show that ViWatch significantly outperforms the baselines of existing IMU sensing methods by a margin of more than 20% for all three keyboards. The average testing accuracy of ViWatch is around 94% while that of the baselines are all below 74%. We believe that the variations cause the performance reduction using the classification algorithms in existing works of IMU sensing. The Siamese adversarial deep learning with extra unlabeled data significantly improves model accuracy.

We then do an ablation study for the cascaded optimization techniques we propose in Section 4. For Section 4.3, there are two approaches of performing the DANN training using Eqn. (6). First, we can treat the data from the target user as the target domain and all training data (Sₜᵣₐᵢₙ) as the source domain. We call this method DANN 2-Domain model, which is the default method introduced in Section 4.3. Alternatively, we can also treat each user as a separate domain for the domain discriminator. Since we have 100 users in the source domain and one user for testing in the target domain, we refer to it as DANN 101-Domain model.

In this work, we also made other efforts to improve the generalization ability of the backbone CNN model (in Sec 4.2) by implementing some existing algorithms for variability challenges proposed in the literature on human activity recognition. First, we employed Timeseries Generative Adversarial Networks (TimeGAN [73]) to generate synthetic data to enlarge the training dataset and create more diversity. Second, we used a model of a UCI Human Activity Recognition dataset [4], and fine-tune with our finger activity dataset by freezing the weights. Third, we fused the center loss directly (e.g. Siamese) [3, 71] in the backbone model to minimize the intra-class variations while keep the features of different classes separable.

We compare the performance of the backbone CNN model, TimeGan, transferred model, Siamese NN, DANN 2-Domain model, DANN 101-Domain model, and the Siamese-DANN model (Sec 4.4). As shown in FIG. 2.10, the accuracy of the backbone model we designed is 90%. TimeGAN did not improve the performance of the backbone model. It is likely that TimeGAN only learns the dynamics from the data of the known training user while it did not generate any information for unseen users. The transferred model failed to improve any accuracy due to the difference between the data sources: IMU data from the coarse-grained human activities and IMU data from the subtle, fine-grained on-body tapping vibrations can be very different. Siamese NN did not work either. We believe that it is because the data has significant intra-class variations across different users while different fine-grained tapping locations/gestures only have subtle differences. With extra unlabeled data, we observe that the DANN 2-Domain model only has a little improvement (1.5%) compared to the backbone model. This result shows that the skewed domain definition counteracts the benefits of DANN training. The DANN 101-Domain model even has a lower accuracy than the DANN 2-Domain model. This result shows that it may be impractical for domain discriminators to separate hundreds of domains with cross-entropy loss due to over-complicated decision boundaries. If we collect a larger scale dataset (e.g., thousands of users' data), this problem may be worse for DANN. On the other hand, the Siamese DANN we proposed (DANN optimized with the Siamese contrastive loss) has better accuracy (94%). Note that this accuracy can be further improved with more unlabeled data in the real world, which we provide as additional evaluations in the rest of the paper. Thus, we can conclude that, our proposed Siamese-DANN algorithm is better customized than the baselines for the IMU classification problem and improves the accuracy with more unlabeled data collected from daily usage. Note that we compare other supervised domain adaptation algorithms in Section 7.3: Applications and User Study.

7.1.2 Sizes of labeled training data. We alter the size of the backbone training data Sₜᵣₐᵢₙ when evaluating the effectiveness of Siamese DANN training. We start from a small training population of 1 user, and gradually increase the training users to 20 users, 40 users, 60 users, 80 users, and 100 users, so that the backbone training sets cover a different proportion of the whole population.

We plot the statistics of the above experiments in the box plot shown in FIG. 2.11. The blue bars show the statistics of the testing accuracy of the backbone model, and the yellow bars show that of the Siamese adversarial training model. On each box, the central mark indicates the median, and the bottom and top edges of the box indicate the 25th and 75th percentiles, respectively. From the results, we have the following observations. First, the model accuracy increases monotonically as more labeled training data is available, which is intuitive as more data leads to better machine learning models. Second, the Siamese adversarial training model outperforms the raw backbone CNN models in all cases—the yellow bars are always higher than the blue ones. This Siamese DANN adaption can provide a stable 4%˜11% average performance gain.

7.1.3 Sizes of unlabeled training data. We also further explored the amount of unlabeled target user data needed for Siamese adversarial training to become effective. In other words, we evaluated the effect of the size of Tₜᵣₐᵢₙ on the performance of Siamese adversarial adaptation. We fix the sizes of source domain training set Sₜᵣₐᵢₙ to be 50 users and 100 users, and we gradually increase the size of Tₜᵣₐᵢₙ from 0, 5, 15, 25 to 35 samples for each key. The mean testing accuracies are shown in FIG. 2.12: the testing accuracy gradually increases as more unlabeled training data (Tₜᵣₐᵢₙ) are used. This trend remains the same no matter whether the training set Sₜᵣₐᵢₙ contains 50 or 100 users. In general, the Siamese DANN benefits more when the amount of unlabeled target user data increases.

### 7.2 Real-Time Evaluations

In this section, we evaluate ViWatch in a real-time manner under various disturbances. We recruited an additional 20 new participants. For each condition, participants were asked to tap 120 random keys we provided as a test set for three keyboards separately. This test set is repeated multiple times under varying conditions. For instance, the 120 samples are executed gently, then repeated with more force. Note that we do not empirically evaluate false positive of finger tapping here because existing work [11] has well addressed this challenge by identifying finger-tapping signals from noisy data, and we also only start detecting signals when users unlock the touchscreen to turn on the app and perform the activate gesture. As results from the three keyboards are similar, we only show their average accuracy in this section.

7.2.1 Backbone Model. The additional 20 users we recruited have different hand shapes. We asked participants to input the test set by tapping on three keyboards using the same pre-trained model. As shown in FIG. 2.13, the average accuracy for 20 users is 90% with 8.6% standard deviation. From FIG. 2.13, we can see that the accuracy is not good enough without the adaptation. Especially, User 5 and User 7 have much lower accuracy. We believe this is because these two users have much fatter hands than the others. Note that different users (hand shapes) not only have different hand shapes, but also may have different tapping strengths, and smartwatch worn positions. Although we have collected 114 participants' data for the training model, the accuracy can still be poor for unseen users, such as User 5 and User 7. In the following sections, we used the Siamese adversarial deep learning algorithm based on the backbone model to improve the accuracy with unlabeled data generated from daily usage.

7.2.2 Adaptation over Time. In this experiment, we verify whether ViWatch adapts to a specific user's typing pattern using the Siamese DANN training. We asked users to input the test set (120 random keys for three keyboards separately) one time every day for one week. To prevent noise of everyday activities from polluting the dataset, ViWatch only detects tapping vibrations when users unlock the smartwatch screen to turn on ViWatch and perform the activate gesture. After each day, we update the models using the unlabeled data generated by regular tapping. For example, the model update process can be executed when users are sleeping. As shown in FIG. 2.14, the accuracies for seven days are 90.1%, 95.2%, 96.4%, 96.8%, 96.7%, 97.2%, and 97.1%, respectively. We have noticed a big improvement in accuracy on the second day. This effectively demonstrates that DANN adapts the model to specific users. The accuracy then showed slight improvements over the following week. Particularly for some previously unknown users, performance has improved significantly. (e.g., the accuracy of user #5 in FIG. 2.13 improves from 65% to 95%.)

7.2.3 Different Tapping Strength. After adaptation over a week, We asked participants to input a test key sequence by tapping the three keyboards gently. Then, we asked them to input the test set again by tapping harder (for the one-hand control keyboard, and we asked them to perform the gestures with different strengths instead of tapping). The recognition accuracies for different strengths are similar (97.2% and 97.4% respectively). Therefore, ViWatch is resistant to different tapping/acting strengths.

7.2.4 Wearing positions of smartwatches. We further measured the smartwatch displacement, which might impact the reliability of Vi-Watch. We asked participants to tap the test set with seven different smartwatch locations each. Location 0 means participants wear the smartwatch on the wrist closest to the fingers, with a comfortable tightness. We asked participants to input the test set with seven smartwatch locations each, which moved the smartwatch away from the fingers by 1 mm, 4 mm, 8 mm, 12 mm, 20 mm, and 30 mm. We observe that users cannot move the watch more than 30 mm away from location 0 because the arm becomes thicker. On average, the classification accuracies are 97.1%, 97.4%, 96.9%, 97.2%, 96.8%, in order. Thus, ViWatch is resistant to the displacement of smartwatches.

7.2.5 Different Tapping Fingers. We also questioned whether using different fingers for tapping affects the system performance. We asked participants to tap the test set using the index finger, middle finger, and ring finger, in order. The results are 97.3%, 97.1%, and 96.9%, respectively. Therefore, ViWatch is reliable to different tapping fingers.

7.2.6 Arm Orientations. In practice, users might maintain different gestures when they are tapping. To evaluate the impact of such variations, we evaluated the system under three different gestures of forearm rotation: (1) gesture 0 indicates that the plane of the back of the hand is parallel to the ground, (2) gesture 1 indicates the arm rotates 45 degrees outwards from gesture 0, (3) gesture 2 indicates the arm rotates 45 degrees inwards from gesture 0. The accuracies are 96.9%, 97.1%, and 97.3%, respectively. The results show that different arm rotations do not compromise the accuracy.

7.2.7 User States. To investigate how human mobility affects classification accuracy, we conducted an experiment to study the accuracy of our system while walking and tapping simultaneously. The accuracy is 96.5% on average. Washing hands is also a typical activity that users complete many times a day. There is no impact on the performance (97.2%) of ViWatch when testing on wet hands.

7.2.8 Different Smartwatches. Additionally, we asked participants to wear different smartwatches to perform the test set. In addition to the HuaweiWatch2 that we have used to collect 100 participants' data, we also use the ASUS Zenwatch 2, and the Madgaze Watch for testing. The IMU sampling rates of them are 200 Hz and 500 Hz, respectively. We match the sampling rate to the Huawei Watch 2. To our surprise, the accuracy for ASUS Zenwatch 2 and Madgaze Watch are 96.6% and 96.8%, respectively. We believe that different types of IMUs should not impact the model performances.

### 7.3 Applications and User Study

In this section, we have developed four applications using ViWatch. Then, by recruiting volunteers to experience these applications, we evaluate system usability (SUS based standard method) and workload (NASA-TLX). Regarding workflow index, we built and asked volunteers to compare another system we built using supervised fine-tuning, in which users are allowed to collect and label some data for the purpose of updating the model every time they encounter variation.

7.3.1 Applications. To evaluate the user experience of ViWatch, we implemented four representative applications. These applications are chosen to demonstrate the broad and important utility of ViWatch. (1) smartwatch games: We developed a maze game in the smartwatch, where the goal for users is to guide a ball to move out of a maze. We use the four-direction keys in FIG. 1.1B direction keyboard: up, down, left, right. (2) Remote controls for smart headsets (can be extended to control many devices): Again, We use the direction keyboard: up, down, left, right, back, and confirm. With this keyboard, users can make selections for menus in smart headsets. (3) Shortcuts to activate apps that are usable in smart spaces: We built a shortcut system in the smartwatch that allows users to customize it. For example, when users tap on key 1 on the dial keyboard as shown in FIG. 1.1A, the smartwatch turns on Google maps. When users tap on key 2 on the dial keyboard, the smartwatch turns on the music player, etc. (4) One-hand controls: We connected the smartwatch to Madgeze smart glasses and a laptop. We used one-hand controls to control smart glasses and play slides. Users first used one-hand controls to zoom in and zoom out of a google map on the smart glasses. Then, they swung the palm to the left/right to switch menus in the smart glasses. Additionally, they used this keyboard to select and play YouTube videos. In the end, users swing the palm to the left/right to switch slides on the laptop.

ViWatch control is helpful for these applications. For example, when users play video games on the watch, the small size touch screen is fully covered by game videos and has no space for an on-screen keyboard. For another example, users' eyes are blocked wearing a smart headset. Therefore, they cannot see and control the smartwatch touchscreen. However, tapping on the skin and performing gestures are eyes-free. One-hand Controls are also helpful, especially when a user's hand is busy and not available. Most importantly, there are more and more wearable devices with no touch screen, such as some sport wristbands. ViWatch can be used to control these no-touch screen wearable devices, as well as controlling smart IoT devices remotely.

7.3.2 User Experience. In this section, we study the system usability and workload. We invited 20 participants to use each application for 10 minutes per day for one week. We updated the model every day by collecting users' unlabeled data without users' notice using the Siamese adversarial neural network we proposed. After experiencing these four applications for a week, we adopted the System Usability Scale (SUS) [2] based standard method to study the user experience. There are ten questions in the SUS [2]. Additionally, we added another question related to smartwatch wearing: I do not need to wear the smartwatch very tightly in order to use this system. FIG. 2.15 shows the scores and the results support that ViWatch is comfortable, user-friendly, and easy to use. To be specific, the questionnaire asked questions with five response options for respondents, from Strongly Agree to Strongly Disagree. The questions and the results are as follows: (1) I think that I would like to use this system frequently. (2 Not Sure, 8 Agree, 10 Strongly agree) (2) I found the system unnecessarily complex. (15 Strongly disagree, 4 Disagree, 1 Not Sure) (3) I thought the system was easy to use. (4 Agree, 16 Strongly agree) (4) I think that I would need the support of a technical person to be able to use this system. (3 Strongly disagree, 13 Disagree, 3 Not Sure, 1 Agree) (5) I found the various functions in this system were well integrated. (5 Agree, 15 Strongly agree) (6) I thought there was too much inconsistency in this system. (16 Strongly disagree, 4 Disagree) (7) I would imagine that most people would learn to use this system very quickly. (1 Not Sure, 5 Agree, 14 Strongly Agree) (8) I found the system very cumbersome to use. (18 Strongly disagree, 2 Disagree) (9) I felt very confident using the system. (2 Not Sure, 7 Agree, 11 Strongly agree) (10) I needed to learn a lot of things before I could get going with this system. (14 Strongly disagree, 5 Disagree, 1 Not Sure) (11) I do not need to wear the smartwatch very tightly in order to use this system. (3 Agree, 17 Strongly agree)

As for the workload index, we built another system using supervised fine-tuning, in which users collect and label some data (10 taps for each key) to update the model every time when they encounter variation. After experiencing both supervised and unsupervised systems, we asked all participants to fill out the NASA task load index (NASA-TLX) [1].

For the mental, physical, and temporal demand, both ViWatch and supervised fine-tuning method have the same low scores (1 or 2), as shown in FIG. 2.16. However, ViWatch has much better performance than the comparison system (18 VS 10). Furthermore, supervised fine-tuning caused much higher effort and frustration scores than ViWatchEight participants reported that the comparison system accuracy was very low when they re-wore the watch on another day, so they had to collect and label data again every day for the supervised fine-tuning method, which was time-consuming and frustrating. Twelve participants said they had to re-collect and label data for the comparison system every two or three days. In contrast, no participants needed to label and collect data using ViWatch. The effort and frustration scores of ViWatch are very low (2 and 3, respectively). ViWatch performance score is 18. Only one participant said that the accuracy of ViWatch is low on the first day usage. 19 participants said that although about 1 out of 10 taps might be wrong on the first day, it is reluctantly acceptable. All participants were surprised on the second day that the accuracy of ViWatch became much better while another system's accuracy dropped a lot. Overall, all participants preferred our unsupervised approach to supervised calibration.

### 8 Discussion

We believe using Unsupervised Siamese Adaptation could be applied to different gestures and sensors in the future. Siamese networks can learn from unlabeled data, which makes them suitable for a wide range of gestures and adaptable to different types of sensors. The unsupervised nature of the network may allow it to adapt to new contexts and expand its recognition capabilities. We will study this in the future.

While we have made our best efforts to recruit volunteers and collect a multi-user dataset, the size of our dataset is still limited. In Section 7.1, the number of training users is capped at 100. While the model accuracy shows a continuing increasing trend with more training data, we are limited by the amount and the diversity of the data. In the future, it would be interesting to explore the training dynamics and performance of our model with more extensive and diversified datasets. For example, we can create multiple large datasets, each containing numbers of users from different ethnic groups, and explore how the model trained on one set will generalize on another as well as how Siamese-DANN will help this transition.

However, keeping each user's model up to date and managing version control can be complex. We may use microservices architecture and automated deployment pipelines to manage models efficiently. Also, training deep learning models requires significant computational resources (GPU/CPU power, memory, storage) and time. When scaled to millions of users, this could become unfeasible. We believe it is important to study an efficient model for on-device training in the future.

Furthermore, unsupervised learning is also affected by the quality of input data. If the data is noisy, incomplete, or inconsistent, the model can produce less reliable results. Note that we do not empirically evaluate false positive of finger tapping here because existing work [11] has well addressed this challenge by identifying finger-tapping signals from noisy data, and we also only start detecting signals when users unlock the touchscreen to turn on the app and perform the activate gesture.

There are several situations that ViWatch will fail the expectations. For example, when users grab an object on the hand which wears the smartwatch. These touched objects significantly change the hand vibrations and affect the system performance. For now, users are instructed to use ViWatch without holding objects. We will study this limitation in the future.

### 9 Conclusion

In this paper, we present ViWatch, the first robust fine-grained finger interactions with COTS smartwatches under deployment variations using unsupervised adaptation. During the development of ViWatch, we explore the possibility of resistance to variations using unlabeled data from the users. Therefore, we designed a novel unsupervised Siamese adversarial training, which optimizes the domain discriminator in a Siamese manner. Our approach is potentially helpful for other time-series datasets on which deep learning model performance suffers from variations. With this method, our final online system achieves 97% accuracy under different deployment variations, such as different hand shapes, finger activity strengths, and smartwatch positions on the wrist. When compared with supervised methods, ViWatch receives more favorable feedback.

With reference to FIGS. 1.1A through 2.16, in view of the foregoing discussion, below is a description of various example embodiments of the present disclosure. It is understood that the below embodiments are not an exhaustive recitation of the possible embodiments of the present disclosure.

Embodiment 1 is an apparatus, comprising a device configured to be positioned on a human body, a vibration sensor in the device, and at least one processor circuit in the device, the at least one processor circuit having a memory comprising instructions. The instructions, when executed by the processor circuit, causes the at least one processor circuit to at least input a sample of vibration data from the vibration sensor into a trained convolutional neural network, the vibration data having been generated from a vibration event, the trained convolutional neural network outputting one of a plurality of predefined vibration event descriptors; and wherein the trained convolutional neural network is adapted based at least in part on a plurality of Siamese contrastive loss calculations, each Siamese contrastive loss calculation being generated from a corresponding pair of preexisting samples of vibration data from a pool of preexisting samples of vibration data.

Embodiment 2 comprises an apparatus as set forth in embodiment 1, wherein the pool of preexisting samples of vibration data further comprises a first portion of the preexisting samples of vibration data being generated from a plurality of source domains, and a second portion of the preexisting samples of vibration data being generated from a target domain.

Embodiment 3 comprises an apparatus as set forth in embodiment 2 wherein the first portion of the preexisting samples of vibration data generated from the plurality of source domains comprises at least 90 percent of a total number of preexisting samples in the pool.

Embodiment 4 comprises an apparatus as set forth in embodiment 2, wherein the second portion of the preexisting samples of vibration data generated from the target domain comprises at least 10 percent of a total number of preexisting samples in the pool.

Embodiment 5 comprises an apparatus as set forth in any one of embodiments 1 through 4, wherein the device is a smartwatch.

Embodiment 6 comprises an apparatus as set forth in any one of embodiments 1 through 5, further comprising: generating by way of a domain discriminator a plurality of instances of a contrast loss based on the pair of preexisting samples of vibration data; inverting individual ones of the instances of the contrast loss; and retraining the convolutional neural network based upon the inverted instances of the contrast loss.

Embodiment 7 comprises an apparatus as set forth in embodiment 6, wherein the pair of preexisting samples of vibration data further comprise a first sample of vibration data and a second sample of vibration data; a feature loss difference in the convolutional neural network is minimized between a first feature loss value and a second feature loss value generated by the domain discriminator from the first and second samples, respectively; and a domain loss difference is maximized between a first domain value and a second domain value generated by the domain discriminator from the first and second samples, respectively.

Embodiment 8 comprises an apparatus as set forth in embodiment 7, wherein a gradient reversal is employed to minimize the feature loss difference and maximize the domain loss difference.

Embodiment 9 comprises an apparatus as set forth in embodiment 7, wherein the feature loss difference is used to retrain the convolutional neural network.

Embodiment 10 comprises an apparatus as set forth in embodiment 7, wherein the domain loss difference is used to retrain the convolutional neural network.

Embodiment 11 comprises an apparatus as set forth in embodiment 7, wherein the instructions, when executed by the processor circuit, further cause the at least one processor circuit to at least initiate one of a plurality of actions that corresponds to the one of the plurality of predefined vibration event descriptors.

Embodiment 12 is an apparatus, comprising: a device configured to be positioned on a human body; a vibration sensor in the device; and at least one processor circuit in the device, the at least one processor circuit having a memory comprising instructions. The instructions, when executed by the processor circuit, causes the at least one processor circuit to at least: input a sample of vibration data from the vibration sensor into a trained convolutional neural network, the vibration data having been generated from a touch interaction, the trained convolutional neural network outputting one of a plurality of predefined touch interaction positions; and retrain the trained convolutional neural network in relation to the plurality of predefined touch interaction positions based at least in part on a difference in loss value of the sample of vibration data compared to a preexisting sample of vibration data, wherein the retraining of the trained convolutional neural network includes adapting the trained convolutional neural network using a plurality of Siamese contrastive loss calculations, where individual ones of the Siamese contrastive loss calculations are generated from a corresponding pair of preexisting samples of vibration data from a pool of preexisting samples of vibration data.

Embodiment 13 comprises an apparatus as set forth in embodiment 12, wherein the Siamese contrastive loss calculations are employed at least in part to remove user-specific variations.

Embodiment 14 comprises an apparatus as set forth in any one of embodiments 12 and 13, wherein the trained convolutional neural network is retrained until a predefined threshold of output accuracy is reached.

Embodiment 15 comprises an apparatus as set forth in any one of embodiments 12 through 14, wherein the pool of preexisting samples of vibration data further comprises a labeled portion of the preexisting samples of vibration data generated from a plurality of source domains, and an unlabeled portion of the preexisting samples of vibration data generated from a target domain.

Embodiment 16 comprises an apparatus as set forth in any one of embodiments 12 through 15, wherein the plurality of predefined vibration events include touch interactions with a predefined touch interaction positions on a human body.

Embodiment 17 is a method, comprising: inputting a sample of vibration data from a vibration sensor into a trained convolutional neural network, the vibration data having been generated from a touch interaction, the trained convolutional neural network outputting one of a plurality of predefined touch interaction positions; and wherein the trained convolutional neural network is retrained periodically based at least in part a plurality of Siamese contrastive loss calculations, each Siamese contrastive loss calculation being generated from a corresponding pair of samples of vibration data from a pool of samples of vibration data generated by individual ones of a plurality of source domains and a target domain.

Embodiment 18 comprises a method as set forth in embodiment 17, wherein the input samples of vibration data and the preexisting samples of vibration data undergo noise reduction prior to input into the trained convolutional neural network.

Embodiment 19 comprises a method as set forth in any one of embodiments of 17 and 18, wherein data related to a domain of the sample of vibration data is removed prior to input into the trained convolutional neural network.

Embodiment 20 comprises a method as set forth in any one of embodiments 17 through 19, wherein the samples of vibration data generated by the target domain comprises unlabeled domain data generated by use of a device that includes the vibration sensor.

In addition, disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. An apparatus, comprising:
a device configured to be positioned on a human body;
a vibration sensor in the device; and
at least one processor circuit in the device, the at least one processor circuit having a memory comprising instructions, that when executed by the processor circuit, causes the at least one processor circuit to at least:
input a sample of vibration data from the vibration sensor into a trained convolutional neural network, the vibration data having been generated from a vibration event, the trained convolutional neural network outputting one of a plurality of predefined vibration event descriptors; and
wherein the trained convolutional neural network is adapted based at least in part on a plurality of Siamese contrastive loss calculations, each Siamese contrastive loss calculation being generated from a corresponding pair of preexisting samples of vibration data from a pool of preexisting samples of vibration data.

2. The apparatus of claim 1, wherein the pool of preexisting samples of vibration data further comprises a first portion of the preexisting samples of vibration data being generated from a plurality of source domains, and a second portion of the preexisting samples of vibration data being generated from a target domain.

3. The apparatus of claim 2, wherein the first portion of the preexisting samples of vibration data generated from the plurality of source domains comprises at least 90 percent of a total number of preexisting samples in the pool.

4. The apparatus of claim 2, wherein the second portion of the preexisting samples of vibration data generated from the target domain comprises at least 10 percent of a total number of preexisting samples in the pool.

5. The apparatus of claim 1, wherein the device is a smartwatch.

6. The apparatus of claim 1, further comprising:
generating by way of a domain discriminator a plurality of instances of a contrast loss based on the pair of preexisting samples of vibration data;
inverting individual ones of the instances of the contrast loss; and
retraining the convolutional neural network based upon the inverted instances of the contrast loss.

7. The apparatus of claim 6, wherein:
the pair of preexisting samples of vibration data further comprise a first sample of vibration data and a second sample of vibration data;
a feature loss difference in the convolutional neural network is minimized between a first feature loss value and a second feature loss value generated by the domain discriminator from the first and second samples, respectively; and
a domain loss difference is maximized between a first domain value and a second domain value generated by the domain discriminator from the first and second samples, respectively.

8. The apparatus of claim 7, wherein a gradient reversal is employed to minimize the feature loss difference and maximize the domain loss difference.

9. The apparatus of claim 7, wherein the feature loss difference is used to retrain the convolutional neural network.

10. The apparatus of claim 7, wherein the domain loss difference is used to retrain the convolutional neural network.

11. The apparatus of claim 7, wherein the instructions, when executed by the processor circuit, further cause the at least one processor circuit to at least initiate one of a plurality of actions that corresponds to the one of the plurality of predefined vibration event descriptors.

12. An apparatus, comprising:
a device configured to be positioned on a human body;
a vibration sensor in the device; and
at least one processor circuit in the device, the at least one processor circuit having a memory comprising instructions, that when executed by the processor circuit, causes the at least one processor circuit to at least:
input a sample of vibration data from the vibration sensor into a trained convolutional neural network, the vibration data having been generated from a touch interaction, the trained convolutional neural network outputting one of a plurality of predefined touch interaction positions; and
retrain the trained convolutional neural network in relation to the plurality of predefined touch interaction positions based at least in part on a difference in loss value of the sample of vibration data compared to a preexisting sample of vibration data, wherein the retraining of the trained convolutional neural network includes adapting the trained convolutional neural network using a plurality of Siamese contrastive loss calculations, where individual ones of the Siamese contrastive loss calculations are generated from a corresponding pair of preexisting samples of vibration data from a pool of preexisting samples of vibration data.

13. The apparatus of claim 12, wherein the Siamese contrastive loss calculations are employed at least in part to remove user-specific variations.

14. The apparatus of claim 12, wherein the trained convolutional neural network is retrained until a predefined threshold of output accuracy is reached.

15. The apparatus of claim 12, wherein the pool of preexisting samples of vibration data further comprises a labeled portion of the preexisting samples of vibration data generated from a plurality of source domains, and an unlabeled portion of the preexisting samples of vibration data generated from a target domain.

16. The apparatus of claim 12, wherein the plurality of predefined vibration events include touch interactions with a predefined touch interaction positions on a human body.

17. A method, comprising:
inputting a sample of vibration data from a vibration sensor into a trained convolutional neural network, the vibration data having been generated from a touch interaction, the trained convolutional neural network outputting one of a plurality of predefined touch interaction positions; and
wherein the trained convolutional neural network is retrained periodically based at least in part a plurality of Siamese contrastive loss calculations, each Siamese contrastive loss calculation being generated from a corresponding pair of samples of vibration data from a pool of samples of vibration data generated by individual ones of a plurality of source domains and a target domain.

18. The method of claim 17, wherein the input samples of vibration data and the preexisting samples of vibration data undergo noise reduction prior to input into the trained convolutional neural network.

19. The method of claim 17, wherein data related to a domain of the sample of vibration data is removed prior to input into the trained convolutional neural network.

20. The method of claim 17, wherein the samples of vibration data generated by the target domain comprises unlabeled domain data generated by use of a device that includes the vibration sensor.
